(19) United States
(12) Patent Application Publication
(10) Pub. No.: US 2020/0311816 A1
(43) Pub. Date: Oct. 1, 2020

(54) DISTRIBUTED LEDGER INVESTMENT GOVERNANCE PLATFORM

(71) Applicant: PetroChain Holdings, Inc., Albuquerque, NM (US)

(72) Inventor: Ross Way Calvin, Albuquerque, NM (US)

(73) Assignee: PetroChain Holdings, Inc., Albuquerque, NM (US)

(21) Appl. No.: 16/829,763

(22) Filed: Mar. 25, 2020

Related U.S. Application Data
(60) Provisional application No. 62/823,326, filed on Mar. 25, 2019.

(51) Int. Cl. G06Q 40/06; G06Q 20/06; G06Q 20/40; H04L 9/06

(52) U.S. Cl. CPC G06Q 40/06; H04L 9/0637; G06Q 20/405; G06Q 20/0658

(57) ABSTRACT

A cryptographic system and mechanism for combining the authenticating of industrial activity and processes and placing investments. Embodiments of the present invention can provide a system that allows for transmitting and filtering oil and gas transactions through a comprehensive, interlocking distributed ledger-based supply chain ecosystem and cryptocurrency-enabled capital funding mechanism, so that such transactions can be monetized to reduce costs, execution times, and risk, while elevating information quality.

### CROSS-REFERENCE TO RELATED APPLICATIONS

This application claims priority to and the benefit of the filing of U.S. Provisional Patent Application No. 62/823,326, entitled “Distributed Ledger Investment Governance Platform”, filed on Mar. 25, 2019, and the specification thereof is incorporated herein by reference.

### BACKGROUND OF THE INVENTION

Embodiments of the present invention relate to cryptographic systems. More specifically, embodiments of the present invention relate to a cryptographic mechanism for combining the authenticating of industrial activity and processes and placing investments. More particularly, embodiments of the present invention relate to a system that provides the ability for transmitting and filtering oil and gas transactions through a comprehensive, interlocking distributed ledger-based supply chain ecosystem and cryptocurrency-enabled capital funding mechanism, so that such transactions can be monetized on a granular level to reduce costs, execution times, and risk, while elevating information quality.

Oil and gas upstream supply chain transactions are affected by points of friction caused by antagonistic counterparty relationships, low-trust, low-technology, information asymmetry and opacity, high capital costs and time to market. These challenges are largely interrelated. There is a need for a system which can prevent a challenge specific to one type of counterparty relationship from propagating into other relationships and which can lower friction, capital costs, time requirements and risk across a wide array of counterparties.

Some disadvantages with known processes employed in the oil and gas and energy industry include funding gaps, mutual trust issues, and transparency problems. In general, resistance to technology leads to funding gaps. Lack of operator transparency and risk management constraints lead to investment liquidity issues. Additionally, there tends to be a service provider and operator trust gap that results in problems. For operators, problems include high capital costs, delays with time to market, title perfection, and vendor selection. For investors, problems include project transparency, risk management, liquidity, dispute resolution, and audits. For vendors, problems include payment delays, high leverage, and carrying operator expenses.

Further problems and disadvantages with current systems include: Oil and gas investment managers create barriers to efficient capital allocation. Oil and gas investment brokers are expensive, create friction, and are of questionable effectiveness. Independent oil and gas operators have low trust, and often retain a low percentage ownership and high costs of capital. Independent oil and gas operators often spend up to 50% of their time seeking financing, reducing time spent implementing development projects. Independent oil and gas operators often must raise their entire three to five-year capital requirements in one transaction. An inability to do so can cause a drastic over or undershoot in capital needs which can cause investor dilution and project stoppage. Independent oil and gas operators must often combine many different securities types from many different competing capital partners which can cause extreme time delays in ultimate project capital formation. Independent oil and gas operators must often pledge personal guarantees to traditional financing sources, and many types of collateral are insufficient.

Compliance with financial reporting standards for both royalty owners and public equity financing can be expensive and onerous, and large amounts of management's time can be devoted to non-accretive investor relations. Siloed, non-distributed capital allocation managers experience relatively rapid diminishing marginal returns of equity financing. Legacy securities market voting and stockholding infrastructure is inherently prone to misstatements. Investor proxy vote governance conventions for publicly-traded firms are prone to highly inaccurate share counting and over-issuance due to reconciliation problems which develop through multiple layers of intermediary custodians and counterparties. Investment governance hindered by financial intermediary counterparty risk. Oil and gas projects are often driven by tax incentives rather than project merit, causing waste, poor capital allocation decisions, and incentivizing independent oil and gas operators to misstate project realities due to investor price insensitivity, which in turn diminishes industry trust and adds to overall capital allocation friction. General non-well specific industry risks disincentivize technology adoption. Counterparties in the oil and gas development ecosystem have unique trust, transaction, cash flow, operational and financial leverage difficulties which causes fragmentation and resistance to technological improvement in the industry.

Oil and gas projects assembled for investment have low transparency and critical information asymmetry. Oil and gas contract vendors are often highly leveraged, have thin operating margins, and often inappropriately carry the cost of project development. Oil and gas securities are complicated, time consuming, and expensive to form. Legal registration and securities formation are analog, inefficient and expensive. Minor legalistic errors can create exceptionally expensive and time-consuming challenges and drastically reduce project returns. The cost of defending oil and gas asset property rights can be prohibitively high, discouraging capital allocation. The limitations of conventional banking create cash flow tightness and friction in accounts receivable and accounts payable. Oil and gas investments often have lockup periods of greater than five years, subjecting investors to pronounced liquidity risk and deeper exposure to commodity price cyclicality. Oil and gas investment illiquidity creates a double-coincidence of wants problem whereby the operator management and investors must enjoy highly-acute synchrony of goals and strategies, which stalls capital formation. Presently there is no solution to allocate capital and confirm assets and transactions in a distributed way without individual investment managers acting as capital custodians, title companies acting as title custodians, and banks acting as clearing agents, all of which create information, transaction and capital allocation friction.

Market overview: Macro-energy capital markets in the US are dominated by large private equity pools and publicly-traded firms able to access public share capital funding for development. Below this, smaller private equity pools and broker-dealers aggregate family-office and high-net-worth individuals as capital sources. Often, lower-tier investors require the participation of higher-tier co-investors in order to allocate capital. Investment demand is highly driven by commodity prices, which are in turn highly sensitive to international monetary and political agendas. Organization of Petroleum Exporting Countries (“OPEC”) nations' domestic currency regimes, Chinese marginal credit creation, and the state of the organization for economic co-operation and development (“OECD”) debt markets drive energy prices generally, as well as price volatility. As a consequence, capital costs and access for many independent producers can be both volatile and high for sustained periods in a manner divorced from the economics of individual energy development projects.

Furthermore, after 2009, emerging market real economic growth drove expansion in barrels per capita and propelled global supply tightness. In 2017, the International Energy Agency (“IEA”) estimated that one third of incremental global energy demand will come from India alone, and that China's clean energy policies will propel the US to the globe's #1 LNG exporter and a net overall energy exporter by 2020. This supply tightness combined with the prospects for higher global consumer price index (“CPI”) driven by expanded central bank inflation policies translated into mass adoption of superior, but cheap credit-fueled extraction methods in the US. In turn, this translated into a strengthening US dollar owing to higher domestic production and curtailed oil imports. The curtailed export of US dollars for oil import purchases, and the ensuing global supply tightness in US dollars triggered a chain reaction of global currency devaluations in oil states and altered the 20 year upward-trending oil price floor. This represented a secular regime change in oil dynamics and pricing toward US domestic production dominance, but which also faces increased global competitive pressures.

OECD, and particularly North American, producers must compete with state-owned energy companies which are often in turn supported by their own domestic central banks. As US producers potentially shift into the role of exporters themselves, this translates into a sharp need for competitive advantages across the private energy ecosystem driven by technological improvements, and technical, organizational, and financial efficiencies not currently enjoyed. The International Energy Agency estimated that dynamic prospects for US shale production may propel the US to the number one global producer. Prices above $55 may shift investment demand right on the heels of tightened competitiveness among US producers.

Furthermore, the prospect for sustained lower prices caused a shift in North American investment demand, and thereby development, into developed basins economic at prices below $40, to the exclusion of many other more exploratory or traditionally expensive plays. Add to it that a major portion of North American supply growth has traditionally occurred through independent operators developing exploratory fields. For these smaller firms, capital costs are traditionally upwards of 15% or higher. Technological solutions to reduce capital costs through risk, trust, and investment intelligence distribution such as the system in an embodiment of the present invention have the potential to become extraordinarily valuable by spurring much-needed development in alternative basins.

Along with global competitive currency devaluations over the last eight years, oil states staged a devaluation of their own in 2014, colluding to capture market share at the expense of high prices in the face of competitive extraction in North America. Attempts to squeeze competitive North American producers to secure political and monetary control at home resulted in lower prices and sharply reduced deal flow in the West. Upstream investments fell by 25% in 2015 and another 26% in 2016. While 2017 showed recovery, investment mainly focused on light tight oil in select, well-explored basins. Investment flow reductions exceeded cost reductions, which fell 30% and 22% respectively.

While operators in select basins may be able to raise production in a lower price environment, in general the industry will be forced to deliver more with less going forward. Likewise, capital costs have surged. The disinterest in more speculative plays and the constrained investment climate have precluded even more generous net revenue interest offerings. Despite record high crude oil stocks, the flat crude oil five-year forward curve suggests investors do not expect supply to trail demand, despite the poor investment climate. Renewed supply tightness may be insufficient to immediately drive new exploration and lower capital costs given the effect of a strong US dollar on GDP growth outlook in emerging Asia, an overhang of underwater energy debt, and a damaged risk appetite. The market indicates a protracted period of capital scarcity for all but tight oil projects which also requires operators and service providers to be meaningfully more competitive for longer.

A chief indication of continued risk aversion is the extent to which public energy companies have been compelled to increase shareholder distributions at the expense of development capital expenditure. Energy producers have built in the round possibility of a supply shock and the oversupply of crude oil in 2014-2015 has very likely masked a chronic underinvestment in productive assets. Reserves at major companies have fallen and the industry's reinvestment ratio has fallen to the lowest in 25 years. Proven reserves of the largest oil firms have fallen by 30% on average since 2000. The consequence could likely be that an unplanned supply tightness, driven by unexpected positivity in US GDP growth on one side or increased geopolitical risk on the other, could cause a rapid increase in crude oil prices.

Rigs & Deal flow: Oil and gas well development activity in the United States is performed by between 1,000 and 1,200 land rigs on average. Of these, 88% are horizontal, 6.5% are vertical and 5.5% are directional. Among these, roughly 200 are dedicated to independent operators at any one time. The system in an embodiment of the present invention estimates its transactions will involve projects completed by between 200 and 300 of these rigs (with the additional ˜100 driven by the DAO's ability to participate in non-operating working interests developed by respected independent exploration and productions (“E&Ps”) on acreage held by production).

According to the EIA, the average US onshore well cost has hovered around $6.5M since 2006. Generally, rig and drilling fluid expenses count for roughly 15% of total development expenses, meaning drilling expenses for an average well range from $900,000-$950,000, and operate for an average of 31.67 days at current day rates of ˜$30,000. At an average utilization rate of 75.4%, this indicates this population of rigs will develop 1,738 well sites in a year for a total of $11.3B in total well development expenses per year. The second 100 rig tranche from the population of on non-operating working interest projects represents an additional $5.6B in well development capital expenses and another 869 wells developed.

Independent operators: Oil and gas is notoriously procyclical. When commodity prices are high, the discipline in both investing and execution of wellhead development both tend to degrade. The consequence is more waste today and more assumed risk tomorrow. This increases capital costs and legal burdens for capital formation for everybody in the industry. When prices are high, investors are less sensitive about selecting operators and contract vendor teams. When prices are high, operators look to turn out as much production as possible with whatever vendor assets happen to be available. When prices are high, vendors are constantly rushing to finish one job to get to the next, and poor execution choices are made. This is true regardless of the scale of project or operator.

Independent exploration projects under $25M in size have suffered more acutely from this period of weak funding appetite. Traditionally these assets which already suffer from lower levels of investor trust and transparency, are generally more speculative, and therefore are also constrained for capital. Moreover, these projects typically fall within a large funding gap, too large for retail investors (above $500,000), yet too small for institutional investors (below $25M). These projects are therefore funded by individual investors and small private equity partners with limited risk budgets, and which may be difficult to approach or simply be unknown to individual exploration teams. The market suffers from wide inefficiencies which are very costly to bridge.

Independent exploration firms (operators) also find that regulations around capital raising are onerous and time consuming. Registration requirements, time lost and other opportunity costs, difficulty identifying capital, and legal expenses are often prohibitive for firms capitalized under ˜$25M. The market is characterized by excessive frictional control by larger oligopolistic entities which often profit from diseconomy rather than competitiveness. This segment of the industry often poses higher risks to investors, both due to its exploratory nature and a higher investor susceptibility to misrepresentation by promoters and operating companies. As a result, individual investors benefit from risk diversification across many exploration projects, management teams and geographies. There is a pronounced need for higher transparency, the democratization of risk, and capital access through syndication of energy project funding and through advancements in secondary trading of working and royalty interests.

By providing a platform to unite these investors and projects with advanced cryptographic security and investment governance, an embodiment of the system of the present invention bridges this costly gap and alleviates this costly friction. Optimizing these operational and capital market efficiencies into one seamless funding platform meaningfully encroaches on the traditional funding methods of projects larger than $25M as well. Likewise, the investor pool size can increase by ˜20× when allowing digital peer-to-peer transactions within this syndicated decentralized ecosystem.

Problems exist with funding gaps, mutual trust, and transparency. Presently, there are technology resistance and funding gaps. With operator transparency, there are factors of risk management and investment liquidity. There is also a trust gap for service providers and operators. Also, for operators, there are high capital costs, time to market is delayed, title perfection issues and vendor selection. For investors, project transparency, risk management, liquidity, dispute resolution and audit all present problems. Finally, for vendors, there are problems with payment delays, high leverage, and carrying operator expenses. There is thus a present need for a system that provides a solution to these problems by providing a single, distributed, cryptography and cryptocurrency-based, unifying intermediary for asset and transaction authentication, project financing, and investment returns attribution.

There is further a need for a system that facilitates investment access for emerging market investors directly to private markets from which they have traditionally been excluded, at the time when energy markets begin to experience a great surge in demand driven by emerging market fundamentals, and while simultaneously creating a tool for domestic US firms to increase competitiveness.

### BRIEF SUMMARY OF EMBODIMENTS OF THE PRESENT INVENTION

Embodiments of the present invention relate to a method for group evaluation and funding of projects with accountability that includes an operator proposing a project; forming a group of voters and allowing the group of voters to vote to approve or disapprove the project; forming a group of investors to fund an approved project, wherein funds are provided in the form of cryptocurrency tokens; disbursing revenue from the project to at least the investors in the form of cryptocurrency tokens; and assigning a score to the operator based at least in part on the successful completion of the project. In one embodiment, proposing a project can include accepting entry of details relating to the project from the operator in a portal. Optionally, accepting entry of details relating to the project can include accepting entry of details relating to at least one of an oil drilling project, a natural gas drilling project, and an oil and natural gas drilling project. The method can also include requiring the operator to pay collateral for the proposed project, which collateral can optionally be in the form of cryptocurrency tokens. The method can include rewarding voters who voted to approve a project for a project that received a majority vote to approve the project. Optionally, rewarding the voters can be accomplished via payment of the cryptocurrency tokens. The method can also include disclosing an operator's assigned score to the group of voters. In one embodiment, the method can include allowing for real-time audits while carrying out the project.

Embodiments of the present invention also relate to a method for group evaluation and funding of projects with accountability that includes an operator proposing a project; voting by a group of voters to approve or disapprove the project; the operator posting at least some collateral in the form of cryptocurrency; forming a group of investors to fund an approved project, wherein funds are provided in the form of cryptocurrency tokens; disbursing revenue from the project to at least the group of investors in the form of cryptocurrency tokens; and rewarding at least some of the group of voters from the collateral posted by the operator. The method can also include rewarding at least one voter based on a history of voting to approve projects that were found to be profitable. In one embodiment, rewarding at least one voter can include assigning the voter an increased share of an operator's voter incentive bonding and/or increasing voting power of the at least one voter for subsequent projects. The group of voters can include staked currency holders. The method can also provide for execution of multi-signature smart contracts in conjunction with the proposed project and/or allowing for real-time audits while carrying out the project.

Embodiments of the present invention also relate to a non-transitory computer-readable medium that includes machine-readable code, the medium having code allowing an operator to propose a project; code forming a group of voters and allowing the group of voters to vote to approve or disapprove the project; code forming a group of investors to fund an approved project; code providing funds in the form of cryptocurrency tokens; code disbursing revenue from the project to at least the group of investors in the form of the cryptocurrency tokens; and code assigning a score to the operator based at least in part on the successful completion of the project. The non-transitory computer-readable medium can also include code permitting real-time auditing of the project.

Embodiments of the present invention also relate to a non-transitory computer-readable medium that includes machine-readable code, the medium having code allowing an operator to propose a project; code permitting voting by a group of voters to approve or disapprove the project; code for collecting at least some collateral in the form of cryptocurrency; code forming a group of investors to fund an approved project; code distributing funds which are in the form of the cryptocurrency tokens; code disbursing revenue from the project to at least the group of investors in the form of cryptocurrency tokens; and code rewarding at least some of the group of voters from the collateral posted by the operator. The computer-readable medium can also include code rewarding at least one voter based on a history of voting to approve projects that were found to be profitable. The non-transitory computer-readable medium can also include code permitting real-time auditing of the project, code assigning a score to the operator based at least in part on the successful completion of the project, and/or code providing for execution of multi-signature smart contracts in conjunction with the proposed project.

Context—the system and currency regimes: What backs the United States dollar? The dollar would barely exist if not for an extended payment ecosystem consisting of the repo market, Fed window, Visa and Mastercard, SWIFT and Western Union, etc. The value of this payment processing ecosystem itself within the S&P 500 is upwards of $600B, not including non-United States companies or the smaller associated hardware and service companies.

With regard to what backs the currency, the system preferably enjoys the backing by an asset and transaction authentication ecosystem and capital allocation governance mechanism. But rather than this ecosystem resting outside the token as with the United States dollar, this entire ecosystem preferably exists imbedded within the currency token itself. The currency token is preferably the carriage mechanism to port purchasing power across this authentication ecosystem and support and increase that purchasing power through the distributed investment intelligence directed at energy project selection. This payment and intelligence ecosystem is preferably embedded and intertwined into the currency token, just as the value of the dollar's external payments processing system anchors the value of paper notes.

To understand the value of an instrument as a money, one should understand the instrument or commodity's stock-to-flow ratio. In contrast to paper notes, and even with respect to gold versus silver, some commodities have large supplies and small supply growth rates. These commodities function well as monies because they approach as closely as possible the essential monetary value requirement of a fixed quantity. In one embodiment, the system is preferably configured to maintain a high stock-to-flow ratio with a combination of burning (potentially dividends) and especially by ensuring the currency is expensive and difficult to produce, minting only when oilfield work is done at the end of a rigorous investment proxy selection process.

Comparing Bitcoin to traditional commodities, it also has a high stock-to-flow ratio. While there is a fixed ultimate supply of Bitcoin, it will not be reached until mining creates the required inflation to arrive there. Bitcoin's value is its immutable ledger of payments. People pay for this value through the inflation cost caused when transactions are authenticated. Similarly, currency holders pay for the value of its payments, asset authentication, investment governance mechanism, and resultant wellhead-driven increase in purchasing power, through an inflationary effect. However, unlike Bitcoin, where value discovery is produced through gross inflation, currency value generation preferably occurs through net inflation. The currency's ultimate inflation preferably occurs as the slippage between inflation driven by newly-funded oilfield work, and deflation caused when the operator's currency buybacks are burned.

Whereas in the modern central bank framework of the US dollar and the Federal Reserve, new money created goes to finance waste-prone government spending, with interest attached, in the prospective for currency, inflation goes only to those increasing the purchasing power of the ecosystem's assets and to those updating the transaction ledgers. Thus, like Bitcoin, the seigniorage goes back into the currency “money” itself. Those who benefit from the inflation are those securing the ecosystem's transactions and those doing the dangerous, hard work of producing real world energy volumes.

Furthermore, in an embodiment of the present invention, the currency requires far lower invested capital than the existing energy payments processing ecosystem, and will enjoy a far higher return on invested capital as well. Consequently, the currency deserves a higher multiple than applied to legacy US Dollar payment providers. This valuation multiple in turn can be used to reestablish new purchasing-power-generating assets on a continuous basis which further increases the invested capital base. And, it can do so in a superior way to focused, siloed, biased, and opaque investment judgment regimes because it is distributed.

Thus, the currency should be thought of as a hardened final commodity in exchange. First, owing to the imbedded market capitalization allocation gearing, the cost of defending the investment governance regime is lower than the cost to attack it, which continues to adjust favorably as the network grows larger. Second, the growth in the value of the currency can only make the ecosystem less prone to attack through greater degrees of distributed investment governance matched to larger currency holding quantities.

Growth in the market cap preferably attracts more serious and dedicated investment governance to the ecosystem as a consequence of its ability to fund ever larger energy projects. The higher the investment governance quality, the higher quality the projects, the more durable the asset value and the more professional the purchasing power generation activity. The larger the network becomes, the higher the stock-to-flow ratio. The currency gets more useful as a savings mechanism the larger and more populous the ecosystem becomes, but without eliminating its “flow” dimension altogether attributed to new oilfield work performed.

In an embodiment of the present invention, the processes employed allow users to pledge new forms of trustless, lower-cost, low-friction collateral to finance commodity production. Users implement embodiments of the invention to diminish transactional friction in the industry, freeing more resources for commodity production activities. Additional advantages of embodiments of the present invention include: early expansion where token market cap drives new project funding; early adopters that attract token speculators and operators who reward voters; growth surge where rewarded voting and market protocols fund superior projects; and mass adoption where market cap growth attracts institutional capital, projects and intelligence.

Embodiments of the present invention can reduce the costs of capital, time to market, legal fees, and trust burdens, and increase transparency and returns on equity. In one embodiment, the present invention can optionally be used for a mix of minerals, overriding royalty interest, and non-operating working interests. The tactics used can include tokenization of energy assets, asset authentication and project transparency, wisdom of crowds and the aggregate with thousands of small investors, project risk buckets, operator crypto bonding and credentialing, autonomous market risk exposure limits, immediate payments to service providers, and revenues to token holders.

According to embodiments of the present invention, an investor-directed energy investment vehicle is provided which can function as a distributed autonomous organization. It serves as a distributed capital market for private energy exploration that lowers capital costs, speeds up time-to-market, and provides greater authenticity and trust in oilfield operations and investing. An embodiment of the present invention is preferably constructed on the Ethereum blockchain and supplemented by the Tangle protocol. The system preferably binds its unique cryptocurrency to digitally securitized/tokenized energy assets and creates seamless value transmission from oilfield service providers to investors. Other platforms and protocols may also be used.

Beyond a set of innovations and integrations of distributed ledger technology into oil and gas transactions and asset structuring, the system's focus can include providing a well-balanced and sustainable ecosystem that better accounts for the needs of users as well as other institutions seeking integration.

The system's market preferably uses its unique cryptocurrency to allow investors to gain diversified exposure to each energy project funded by the ecosystem. Its robust energy project funding mechanism preferably relies on a distributed consensus methodology which includes project risk scores, rewarded proxy votes, an in-depth user reputation system, an autonomous maximum funding protocol, and the execution of multi-signature smart contracts within oilfield operations. The market logic preferably allows service providers to receive timely, dispute-free, reliable payments, operators to fund a diversity of projects, and investors to maintain extreme transparency and risk governance. Embodiments of the present invention foster a combination of distributed professional analytics, sound legal claims and procedures, dispute resolution, and a method to efficiently manage the risks of energy exploration and development, while opening the door to many tens of thousands of investors.

The system's users can benefit directly from oilfield project success across the entire portfolio. With an annualized market turnover of $184B, the ecosystem can lead the energy industry away from siloed judgment regimes populated by entrenched legacy diseconomies, to a unified cooperative governance infrastructure.

The market creates a degree of fungibility and liquidity in nonfungible, illiquid energy assets by generating a secondary market bid for the system currency funded directly from wellhead revenues. Building atop these tokenized physical energy assets, the ecosystem facilitates the more complex activity of controlling the development of these assets through coded ERC-223 and ERC-721 smart contracts and supplemented with the Tangle protocol. Sitting above these development activities, the cryptocurrency itself is a tradable membership token in the distributed autonomous organization which owns claim to tokenized energy assets, makes capital allocation decisions and benefits from energy project outcomes through market cap expansion and valuation growth.

The ecosystem is a dynamically self-supporting capital funding mechanism to enroll untapped capital sources and best-of-breed investor intelligence governance to optimize energy development activity with unprecedented authenticity.

In an embodiment, for investors, the system acts like equity in the results of the market's hydrocarbon production portfolio. For members, it acts like a ticket to rewards in the selection of superior energy projects submitted for funding. For operators and service providers, the system is preferably the currency in which bills are paid, work is proven, and reputations are built.

Embodiments of the present invention can facilitate a myriad of full-spectrum feature sets, including but not limited to one or more of the following:
Real-time, global asset performance tracking and risk exposure measures;
A clickable, modular asset tokenization engine;
A credentials and reputation display;
Geographic and horizon analysis;
A vendor payment clearing display;
News feeds and analysis;
A proxy voting terminal;
Modular, testable project risk class;
A vendor/operator team configuration engine;
An algorithmically-driven project team configurator;
Project value chain visibility and performance;
Asset title and provenance histories;
Mobile client and web-based portals;
Extreme data visualization tools;
Breakdown of asset performance by geolocation and horizon;
An intuitive smart contract initiation portal, “fare-free” drag and drop and automated payments;
Globally-transparent project timelines;
Machine learning-based analytics and applications;
Automated capital allocation exposure threshold governance;
Big data-driven ecosystem asset valuation metrics for constant NAV monitoring;
Real-time asset monitoring and yield performance;
IoT interfaces to deliver each asset's digital manifest;
A vast data room of immutable user and asset data;
Historical land/mineral titles since inception;
Owned upstream, midstream and PP&E returns metrics;
Class action lawsuit attorney selection reverse auction portal;
A depth of user experience and richness currently not even available to the majors; and/or
Focus on simplicity of use for a semi-technology-resistant user base.

The system, according to an embodiment of the present invention, comprises a single unifying intermediary in energy transactions. By employing the distributed autonomous organization, it preferably raises liquidity and the speed of energy discovery.

In one embodiment, trust can comprise meticulous funding protocols, extensive participant rankings, and intensive geology/economics. For transparency, this can include immutable smart contracts, double deposit escrow, operator bonding, and rigid, real-time audits. For diversification, the solution according to an embodiment of the present invention can mitigate risk from single team, project and geography. It can provide a resolution for class action lawsuits, property auctions, and autonomous attorney selection. Preferably through its employment of integration into global, investable currency, embodiments of the present invention have liquidity and fungible exposure to all assets through liquid currency. It preferably has participation through incentivized proxy votes, distributed risk, governance and optimized results and returns. The integrity of the system can optionally comprise market security-forward maximum exposure rules for each project. Returns can comprise compounded reinvesting for funding expansion, with currency market cap growth from wellhead revenues.

Embodiments of the present invention also:
1) aggregate relevant investment due diligence information into a single information database containing access to blockchain-based well performance data and other asset data, and blockchain-based individual human actor performance histories and voting histories;
2) use APIs from data stored on the blockchain to combine with centralized risk parameter suggestions which help users govern the amount of capital allocation to a single project;
3) provide distributed capital allocation governance which is driven by blockchain-based voting protocols that curate user reputation scores and aid in vote delegation for more successful capital allocation;
4) provide asset token blockchains that are populated with real-time data delivered in distributed cryptographic protocol format from independent machines attached to each hydrocarbon asset;
5) provide a user interface with blockchain-based data and centralized data through extremely intuitive web-based and native machine-based clients;
6) provide unique cryptocurrency that is tradable on secondary centralized and decentralized exchanges worldwide;
7) provide the ability for contract vendors to be paid through seigniorage generated by immediate inflationary cryptocurrency token creation autonomously activated by “‘smart contract” execution, and provide the ability for operators to purchase cryptocurrency tokens from fiat currency earned through hydrocarbon revenues;
8) allow operator cryptocurrency token purchases to destroy cryptocurrency tokens upon purchase relative to the fiat currency value of the contract vendor work performed;
9) facilitate a broad array of hydrocarbon project securitizations including working interests, royalty interests, and mezzanine equity. These financing terms can apply to a small or a large portion of a project's overall capital requirements and can facilitate pay-as-you-go financing as well;
10) allow elongation of the diminishing marginal return on new financing via the distributed nature of the capital allocation decision making system;
11) erect a single honest ledger for investment governance decisions that is accurate, low cost and low friction;
12) facilitate users to input their track records into immutable ledger format, augmenting the durability of a user's good reputation and decisively preventing those with poor track records or reputations from accessing capital;
13) facilitate far greater investment liquidity than traditionally available by vesting hydrocarbon revenues into a highly-liquid instrument which can reduce the tendency toward wasted capital driven by tax avoidance as well as aid in rapid, inexpensive capital formation by broadening the ability of investors and operators to match goals and strategies;
14) alleviate general industry transaction friction so as to spur other forms of technology adoption and experimentation, thus improving industry resilience and growth rates;
15) automate the complex, manual, back and middle-office processes which make industrial transactions and cash flow timing challenges more expensive than necessary;
16) use distributed ledger technology to reduce the costs of defending real world property rights;
17) mainstream capital funding and lower capital costs through global investor access;
18) optimize and authenticate oilfield transactions;
19) bolster and cheapen compliance and risk management; and/or
20) bridge fault lines between operators and service providers through trust, transparency, diversification, and resolutions.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 illustrates an overview of the process according to an embodiment of the present invention;

FIG. 2 illustrates asset formation according to an embodiment of the present invention;

FIG. 3 illustrates project verification according to an embodiment of the present invention;

FIG. 4 illustrates field operations according to an embodiment of the present invention;

FIG. 5 illustrates currency function according to an embodiment of the present invention;

FIG. 6 illustrates public market interface according to an embodiment of the present invention;

FIG. 7 is a drawing which illustrates a second depiction of a process overview according to an embodiment of the present invention;

FIG. 8 illustrates arrangement of cryptographic regimes according to an embodiment of the present invention;

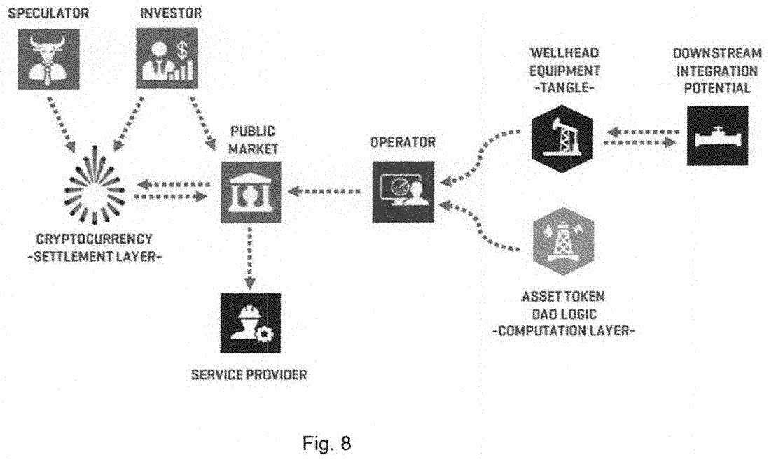

FIG. 9 illustrates a distributed autonomous organization according to an embodiment of the present invention;

FIG. 10 illustrates the system distributed autonomous organization dynamics and self-supporting funding mechanism according to an embodiment of the present invention;

FIG. 11 illustrates the technology of the system, namely, the system blockchain and sidechains;

FIG. 12 illustrates portfolio catalyzing according to an embodiment of the present invention; and

FIG. 13 illustrates catalyst portfolio rotation according to an embodiment of the present invention.

### DETAILED DESCRIPTION OF THE INVENTION

Embodiments of the present invention relate to a blockchain-based capital market for oil and gas development supported by an ecosystem of infield asset and transaction authentication and a unique cryptocurrency bound to digitally-securitized energy assets. The use of distributed ledger and blockchain-based asset tokenization preferably drives oilfield asset and performance authentication, legal formation and distributed capital allocation governance, combined with cryptographic “smart contracts” which facilitate development workflow and drive wellhead revenue purchasing power into a cryptocurrency which serves as the funding pool for new project development. Embodiments of the present invention further decentralize and automate oil and gas development, asset management, and supply chain transactions on the blockchain.

In an embodiment, the distributed autonomous organization allows for a revolutionary type investment vehicle which is investor-directed, can incorporate more than one decision-making party, and more than one stakeholder, including dozens, hundreds, thousands, or even tens of thousands of stakeholders.

Embodiments of the present invention can integrate blockchain-based architectures including facilitating three functions: 1) the creation of capital, including asset titles, securities and production deliveries; 2) banking, including payment clearing mechanisms and cash management tools in the supply chain; and 3) voting, including decentralized and distributed ownership and merit-based proxy capital allocation. In an embodiment, the ecosystem preferably disbursing funds to projects and facilitates profits from investments to flow back to stakeholders. Investment decisions can be made through a voting process and identity/reputation mechanism that creates consensus across jurisdictions with a unified, trustless payment system.

Embodiments of the present invention enable oil and gas transactions to take place without a trusted third party to authenticate work, asset and investment performance. Presently, large oligopoly firms benefit from the complexity, opacity and graft in the industry by a) being viewed as the only safe place for oil investment dollars and b) by absorbing a large amount of the resources needed for exploratory, growth-driving asset development to fund bloated, wasteful organizations which are not defended from hot money flows themselves.

Although oil investors imagine that these firms represent the main baskets of oil and gas information, their bureaucratic structures make the asset of time more-scarce for the rest of the value-producing side of the industry. By absorbing exploratory capital from the growth-driving firms, and therefore elongating project formation times, they paradoxically starve the outside of the industry of the time and lower cost capital needed to develop the very acquisition candidate firms they need to someday acquire for their own reserve growth. Therefore, major oligopolists earn profits not from actual production, but indirectly, from the time siphoned from the exploratory side of the industry, and, in particular, from the excess premium in their equity and debt financing—where lower interest rates enjoyed are a direct measure of markets awarding them greater time value. This “time-siphoning” is greater still when considering the fashion in which energy prices are subsidized through central bank expansionary policies and resultant lower interest rates are earned on the rest of the economy at large.

The blockchain according to embodiments of the present invention is preferably capable of handling intricate privacy rights needed for complex digital assets and digitization of real-world assets which can be routinely copied and for which time-stamped proof of authorship and performance is important. The token used preferably enables immediate, many-sided transactions executed from embedded contracts executed within the blockchain process. These tokens can be underpinned by the time and information value of oil and gas assets and value chain development work and can be linked to the purchasing power of actual oil and gas assets directly.

Embodiments of the present invention can use the Devvio blockchain supplemented with the Tangle protocol and supply-chain-derived hardware assets to create a syndicated investment network and supply chain authentication platform for independent energy exploration and development modelling Ethereum's distributed autonomous organization (DAO). Participants in the ecosystem of embodiments of the present invention are preferably unified through a cryptocurrency which can be utilized in payments for oilfield work and purchased by operators on the secondary market with fiat currency wellhead proceeds. By making this currency available to investors and traders worldwide, embodiments of the present invention open up private energy exploration to historically unavailable global capital.

In an embodiment of the present invention, operators and service providers can be deliberately disintermediated so as to ensure the use of trustless smart contracts in oilfield work and to insert the mechanisms for distributed risk governance as the drivers of energy project funding. By integrating supply chain transaction clearing and capital funding architectures, the technology can lower due diligence costs originating from asymmetric information in work performance and funding and optimize transactions across a wider array of counterparties. By providing a vertically integrated, permanent, non-corruptible data set accessible to all concerned parties, the cost of funding and deploying oilfield work can be reduced. Data integrality can increase counterparty workflow efficiency.

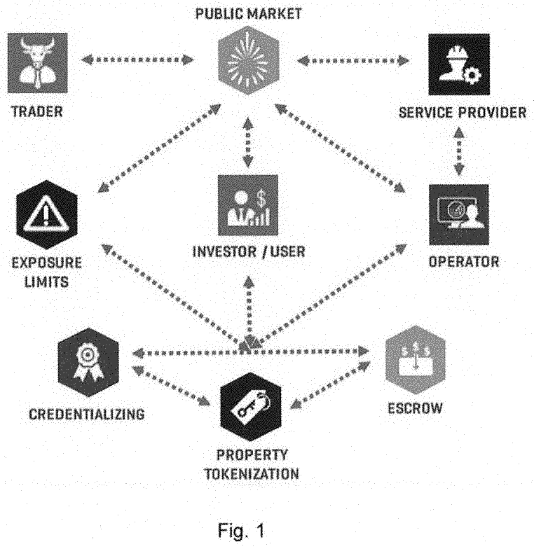

As illustrated in the overview drawing of FIG. 1, embodiments of the present invention provide the ability for service providers to optimize transaction speeds and remove the need for trusting operators. By obligating operators to buy cryptocurrency of embodiments of the present invention from wellhead process, operators can be afforded access to the capital market, which compresses time to market and capital costs. By owning the currency, investors can select the projects which the platform funds, earn rewards for superior project selection, and drive the appreciation of the currency both through superior asset performance and greater capital flows into currency which can optionally be traded on the public markets.

In an embodiment of the present invention, because the ecosystem functions in a decentralized fashion, influential members of the organization preferably compete squarely on terms beneficial to the longevity and health of the network. Therefore, energy project selection and risk governance can be driven by crowd wisdom. This can enable the ecosystem to replace legacy, low-trust oilfield conventions with trustless collaboration between entities whose incentives are aligned and facilitate the ecosystem with a highly liquid capital market in which each user has a stake. In an embodiment of the present invention, preferably, no single role in the system network will be overly controlling or monetizing. Preferably, the system lowers the barriers to entry for energy exploration by bridging the fault-lines of trust and information between service providers and operators and between operators and investors, by disrupting private institutional capital barriers, and eventually barriers created by governments and ineffective legal regimes.

In one embodiment, the ecosystem allows investors to enter the market with less capital than traditional energy investors require and diversify their exposure away from any single project's risks, yet still maintain engagement with best-of-breed project analysis and investment governance, while reducing investor/operator information asymmetry. The system can include energy project selection logic and rigorous oilfield activity verification, market exposure protocols, participation ranking and proxy voting system for investors to gain exposure to growth in oil production at the ground level. By facilitating a market-wide risk management framework to safeguard currency holders, the centralized network aided by imbedded protocols attracts world-wide, democratic investor participation.

Embodiments of the present invention aim to be the primary financing mechanism for hydrocarbon exploration projects worldwide. Beginning with onshore projects under $25M in North America, which currently suffer from an institutional investor funding gap, the system can seed the network with highly-selective projects by advancing these projects the enormous liquidity premium possible through digital tokenization, and park high rates of reinvestment through greater speed in exploration and globalized currency trading.

Underlying asset and user transparency: In an embodiment, the system decentralizes the role of the energy private equity portfolio manager into a distributed autonomous organization which allows for a standardized, trustless credentialing of operators, service providers and energy projects, while seeking to minimize risks to the broader market for the currency which stem from individual project/operator failures. In an embodiment, the platform allows independent energy operators to quickly and flexibly finance projects institutional capital can be unable to fund, while affording the luxury to fund only the most selective. By facilitating global, amalgamated syndication, trading and diversification across hundreds of private independent energy projects, the system provides superior capital access to capital-constrained operator teams, with greater investor transparency, project verification and contract security, while also creating de facto liquidity and fungibility in traditionally-illiquid working interest securities across many separate projects and operator teams.

Embodiments of the present invention preferably establish the architecture for an open, enterprise-grade, shared platform for the immutable recording of financial events, energy production events, project wellhead parameters and dynamics, and energy developer team and industry personnel data. This architecture preferably provides a decentralized database, contract regime and syndicated funding platform, and autonomously facilitates value transfer among syndicated investors. Both mobile, web-based and client investor, vendor and operator dashboards allow for full access to performance and asset data on the underlying portfolio, all with granular, trackable, immutable density and clarity.

Oil and gas transactions can be afforded a method far cheaper than existing platforms for funding and payments because embodiments of the present invention remove an entire layer of overhead dedicated to confirming asset and infield work authenticity. In the system's distributed ledger system, confirmation is effectively performed by everyone on the network, simultaneously, or by those with mutually-agreed-upon credentials. The system's computational consensus layer process can reduce the need for existing intermediaries who touch the transaction and extract a toll in the process, including broker dealers, banks, those adjudicating contracts, tax transactions, store wellhead performance and asset geological information, and the like.

Furthermore, by creating rewards for transaction and work behaviors which are pro-market, embodiments of the present invention preferably optimize counterparty relationships between each vendor, investor and operator. This tokenized metadata concerning user credentials, track records, KYCAML (know your customer/anti money laundering), and even metadata analytics, can be just as valuable to potential oil project investors as immediate, immutable value chain payments are for vendors.

In an embodiment, through the system's platform architecture, the costly requirement for individual trust among counterparties can be sidestepped, allowing users to trust the immutable ledger framework of assets and user operating records instead.

The system's investment decision making preferably principally depends on parties which have posted collateral, and then earned strong reputations by contributing to the soundness of the DAO's asset portfolio over time. It preferably maps to the economic foundations expressed in cryptographic proof-of-stake protocols. At the same time, the system's operating logic preferably provides the world's first way to reduce the great information asymmetries in energy investing and development, which is responsible for the greater fraud, costs and project time that ultimately impede the world's access to cheap, plentiful, reliable energy upon which everything relies. A vertically integrated and complete ecosystem powered by rapid, programmable oilfield asset and transaction smart contracts and tokenization is revolution for the industry.

Macro risk transference: Global government indebtedness totals an unsustainable $233T, while global assets are only $280T. That leaves a spare $47T in wealth compared to an annual interest bill of $11.7T (at a conservative 5% global sovereign bond interest rate), just slightly over four years of wealth worth of interest remaining. Fundamentally, it has become common knowledge that this problem cannot be solved without runaway serial currency devaluations, which already began in 2009. No asset class will be unaffected—every asset class is far more interest rate-sensitive than it was in thirty years ago. The basic monetary unit upstream from national fiat currencies, oil, and its other basic materials cousins will enjoy a portentous path: spot prices and curves should be positively exposed to ongoing devaluation cycles. But monetizing this exposure requires a degree of tactical and analytical access that is enormously expensive to acquire and develop, and thus out of reach to most people.

Therefore, embodiments of the present invention seek to offer exposure to this underlying phenomenon that is incrementally more durable the more the platform value grows. The greater the platform's incremental accumulation of metadata, the greater the portion of the system's value will owe to its weight as the global “computer” for oil and gas wealth development, aside from the actual in-situ assets it controls. Embodiments of the present invention will function as its own source of alpha, in addition to the alpha it helps unlock behind the drill bit. Moreover, the purchasing power from the wellhead will become incrementally more geared to unleashing growth alpha, over and above its exposure to the legacy assets in its portfolio. The system offers alpha exposure to oil production growth and seeks to capitalize on monetary turbulence by functioning as a “meta-data” hardened, “hard money” instrument for oil and gas exposure.

By decentralizing operator, vendor and investor credential information, available to all stakeholders, embodiments of the present invention offer the industry a degree of historically unprecedented trust and assurance. This “metadata-hardened” architecture then serves as the provider of higher trust, and therefore lower costs of capital than the industry enjoys. Meanwhile, individual stakeholders can remain in control of their own critical information, provided that it remains immutable.

Furthermore, in an embodiment, by enmeshing the immutable, recorded work results among individuals, a far more granular picture of asset values, and operational patterns and risks populates real-time asset and platform valuations. By removing points of friction and gates along the value chain from vendor to investor, embodiments of the present invention preferably remove points of potential value capture for agents, custodians and allocators which ultimately decreases project formation costs and time horizons.

In an embodiment, while the vendors available to independent operators, as well as broker dealers, can represent these points of value capture and friction, the entire apparatus of integrated firms ultimately manifests as such gates as well. Embodiments of the present invention are, by contrast, simpler than the internal systems of major firms but have the ability to create exposure to larger asset portfolios, without sacrificing performance and a focus on quality.

In an embodiment, the toll for operator project formation or reaching public markets is upwards of $2M, much of which goes toward rigid accounting regimes high on paperwork and low on trust. It is inimical to the culture required to launch de novo enterprises and projects. “Lawyerization” of company communications can be treacherous and expensive for the company and also strips critical information subtleties from the eyes of would-be investors. All but the largest companies are realms of zero-value communication, regressive meaning and little inside detail. This further hinders independent operators in generating trust for new drilling programs. Meanwhile major energy firms push headlong into a vast enclosure movement. Information flows, and therefore capital flows, do not have scalable streamlined architecture to ensure that sober, calculated risk taking does not move decisively to the edges of the industry.

Today the only comprehensive way for an investor to access an ecosystem which protects property rights, defends privacy, hosts safe and efficient transactions, permits scalable micro transactions to unite supply chains and verify high-quality participants, or establish sure identity, is to build a portfolio of large oil company stocks. A highly imperfect attempt to de-risk by “buying” the industry at large. But the costs of the cumulative bureaucratic overburden of these companies far outweighs any alpha investors could ever expect to generate in this fashion. In placing exposure to these oligopolist beta producers, the only opportunity for alpha is subsumed under their own internal efforts to protect subsidized financing costs.

In an embodiment of the present invention, the system operates as a blockchain architecture that facilitates alpha exposure for investors through a centrifugal process of operator, asset and value chain participant selection and allocation, and strips the need for bureaucratic overburden to manage oil and gas portfolios.

In an embodiment of the present invention, the system operates as a distributed cadastre. Rather than being fully distributed like some blockchain platforms, the system can be a distributed cadastre assuring logical centralization as single sources of transparent ledgers while being organizationally decentralized, e.g., in one preferable embodiment, distributed control over work flow and assets. In another embodiment of the present invention, the platform can separate the control plane from the data plane. In so doing, it may be scalable. In contrast, in some major firms, these layers (expressed in analog business processes) are amorphously conjoined. In some blockchain platforms, conjoining these layers creates computational bloat and prevents scalability. In a preferred embodiment, the system offers a hybrid cryptocurrency media used to represent the monetization of supply chain activity and user credentials as well as port asset purchasing power, and also functions as a utility token for platform participation.

In an embodiment of the present invention, the system can ensure property rights for acreage, minerals, and the production profile of working assets. Through time stamping, algorithmically allocating, and recording of the transference of singular documents, including well flow rates, pad site materials delivery, and capital allocation proxy votes, property claims can be effectively and autonomously apportioned and allocated. In an embodiment, there can be variable transparency as pure transparency may not be advantageous for every actor at every stage of project development. Therefore, the option for privacy can be optionally employed, e.g., to protect assets. The platform of the system preferably allows individual ownership of immutable data to preserve an opacity versus transparency balance to accommodate investor due diligence requirements.

An embodiment of the present invention further uses a barbell architecture. The system provides a stable, predictable, knowable, and monolithic foundation to a subtle, variance driven oil and gas wealth and knowledge.

In yet another embodiment, the present invention can operate as a cryptocurrency hybrid. By tying oil and gas asset value and meta-data value to a medium which allows users to conceal critical information while allowing complete compliance with energy best practices, the system offers a path to durably form capital as well as the ability to unify and monetize distributed supply chain work activities.

The system according to an embodiment of the present invention provides a method for non-traditional investors to own a stake in the aggregate success of many individual energy development projects run by many firms, while the market itself maintains property title, distributes rewards, and expands fungibility and liquidity, facilitates access to capital for operators and offers a greater selection for trustworthy projects into the system's distributed autonomous ecosystem. The system's self-titled unique cryptocurrency facilitates a distributed ledger to all tokenized energy projects, while tokenization houses individual well economics outcomes, royalty owner information, geological information, and working interest economics information that is simple, direct and transparent. The currency also facilitates greater access to capital for hydrocarbon drilling and offers currency owners exposure to production volume growth across the entire market.

Preferably, an embodiment of the present invention answers service providers' needs to be more competitive and less prone to cyclicality, all while demonstrating, executing and being paid for work orders faster and more reliably, with less required trust between parties. The network is structured such that investors and the system DAO members benefit from currency appreciation tied directly to the aggregate net revenue interests that operators owe to currency holders, and benefit from voting and project selection logic which incentivizes successful project selection.

Distributed ledger technology continues to require robust use-cases which demonstrate broad degrees of functionality. In an embodiment of the present invention, the system anchors this technology with live energy producers. In doing so it expands user adoption through incremental expansion in market capitalization via increased energy production volumes from constituent producers. It ultimately translates the blockchain's use to larger energy projects and potentially into other commodities.

As more participants join, the system quickly gains critical mass as a leading platform for decentralized, syndicated energy investing. No more do independent E&Ps find themselves as an underserved part of the energy development value chain nor do investors find themselves at the mercy of radically asymmetric information against both operators and fund managers. Where they have struggled with a lack of transparency and speed in accessing critical deal positions, embodiments of the present invention open up a new plane of access, investor trust, and capital for operators beyond the traditional, constrained, ad-hoc capital access activity and boom-bust experience familiar to many energy investors. Furthermore, many traditional functions of independent oil operators are absorbed into cryptographic functions, such as audit, royalty disbursement (which can trace back for decades), and provision of wellhead performance transparency, providing for a more efficient energy funding platform which attributes gains more effectively to risk-takers.

Supply challenges: Investment capital eagerness is constrained, while supply remains tight. By year end 2017, the attribution of new discoveries to meet total demand had fallen to ˜10%, the lowest since the 1950's. Furthermore, there is general concern that US development will be able to continue meeting supply shortfalls, especially as new production from Permian wells have tapered, opening the door for price to move sharply higher. In an embodiment of the present invention, token holders' ability to modularize investment exposure to include more exploratory projects or projects in basins thought to be less repeatable but still producing can allow the system portfolio to access a greater degree of production growth than the market at large. There are a few tools which offer access to distributed yet sophisticated investment governance yet maintain such growth exposure.

The downturn principally was understood to favor short-cycle shale drilling as a way of reducing risk through the rapid payouts these tight oil formations have offered. Upstream development faces a key macro challenge in that the number of large discoveries are falling. Meanwhile, the industry has a heavy bias toward the repeatability of onshore tight oil plays, and the figures and forward curve dynamics indicate the assumptions of this repeatability is significantly overstated. Global upstream capital expenditures fell nearly 60% from 2014 through 2016, the forecast for capex growth ending in 2025 is only ˜6%. Because traditional supply sources will grow somewhat anemically, there is likely to be a less animated appetite for non-traditional capex as well, where the system according to an embodiment of the present invention can serve to fill some of this gap.

Furthermore, supply from major fields is falling at a decline rate of 4% annually. Investment eagerness in basins with more conventional assets, and with prospectively longer payout horizons and therefore less bank-credit-centric, remains insufficient to match this decline rate. Accountancy E&Y remarks that a persistent widening in the “bid-ask” spread for independent projects has existed since 2015. They believe this will give rise to more innovative deal structures in terms of joint ventures, hybrid equity and strategic partnerships. In both that asset and deal flow dimensions, there is a large underserved market for new projects in these other basins where the system according to an embodiment of the present invention can offer an opportunity.

An embodiment of the present invention can provide an instrument leveraged to the two most compelling market phenomena today: the increasing cryptocurrency market capitalization worldwide and the translation of that value into real-world energy production, and the supply tightness and renewed expansion of oil and gas development in locations which require non-traditional configurations. In an embodiment of the present invention, the total cryptocurrency market capitalization could reach $20T in ten years, up from $225B today, and that there is extraordinary opportunity to translate this valuation increase into new energy production. Concurrently, global upstream capital expenditures announced top $800B until 2025, will require $1.7T in total lifetime capex. The US represents $75B of this initial capex, from a sample of those projects announced by majors, and North America leads in capex growth at a forecasted 7%. Should blockchain and cryptocurrency investments rival the importance of the transmission control protocol/Internet protocol (“TCP/IP”) revolution, that legacy market cap peak coupled with the greatly-volume degree of fiat currency today means a significant multiple of expansion remains. The translation of this market cap into productive hydrocarbon projects further rotates blockchain excesses into fundamental value.

The system according to an embodiment of the present invention aims to offer value to the energy development ecosystem in eleven principal ways.

1. Reduce capital cost, divert difference to investors: An embodiment of the present invention assembles a large pool of capital available for energy development populated by hundreds of thousands of individual currency holders and DAO members by facilitating market integrity risk exposure management, and incentivizing participant credentialing, identity formation and track records where highly-competent energy veterans will be most competitive.

2. Risk compression: In an embodiment of the present invention, amalgamate risks of the entire portfolio of energy projects into one trustless blockchain instrument: hundreds or thousands of tokenized independent exploration projects across tens of thousands of currency holders. Distribute counter-party risk across thousands of independent oil operators.

3. Scalability of access: In an embodiment of the present invention, unaccredited investors are preferably allowed to gain an unallocated exposure to the aggregation of all independent projects combined, while either avoiding or adjudicating project-specific risks, and while benefiting from global risk analysis network.

4. Fraud reduction: In an embodiment of the present invention, there may be an increase in authenticity and transparency through distributed logic by rejecting projects which do not adhere to rigorous economic and operational standards. The currency according to an embodiment of the present invention qualifies as an SEC-registered security because each tokenized project is a security which the system of an embodiment of the present invention owns, and that undivided interest in these assets is akin to ownership in a private equity or investment portfolio. Embedded logic preferably conforms to the most rigorous SEC-registered working interest agreements. A binary distributed ledger of all capital transactions, which can also serve as a de facto surrogate for an SEC-registered working interest security and the source of liquidity usable for leading-edge exploration activity.

5. Work proof: In an embodiment of the present invention, multi-signature smart contracts generate oilfield proof-of-drilling, proof-of-deed/title/option, proof-of-audit, proof-of-oilfield-materials, proof-of-production criteria built in, etc., all embedded in the property's token. Immediate payment upon completion, in currency, links service provider and investor, while obligating operators to return development expenses to currency holders in the form of buybacks.

6. High growth: In an embodiment of the present invention, high-growth sector exposure can optionally be provided. Success of currency directly linked to the aggregate success of the underlying tokenized projects. Currency value rises the more hydrocarbons are produced.

7. Governance evolution: In an embodiment of the present invention, shift governance from paper to a blockchain-based application. The market incentivizes listing high-quality projects and disincentivizes fraud. The system's network bears a much lower fraud tolerance than the current conventions.

8. Improved project quality: In an embodiment of the present invention, by removing the need for operator teams to expend costly months of searching for highly constrained capital, they can devote more resources to geology and project analysis/strategy.

9. Transparency: In an embodiment of the present invention, the system preferably includes an economic ecosystem that is fully transparent and requires a minimum of trust between exploration firms, service providers and investors/coin holders, while preserving opacity when required.

10. Error and legal cost reduction: In an embodiment of the present invention, the system loads title histories and asset perfection into its immutable ledger regime, eliminating the possibility for years of drawn out title disputes due to filing mistakes and nefarious interference.

11. Ethical symmetry/conflict of interest reduction: In an embodiment of the present invention, the illiquidity of working interest agreements creates an involuntary dimension to the contract structure. A fraudulent operator must be sued at the very least. The more involuntary the relationship, the higher the ethics of that relationship must be. There is a large component of most exploratory energy activity which is that it can incentivize loose ethics and provide many places to hide and assets to commandeer. Embodiments of the present invention can serve as the antidote for immense entrenched interests which profit from existing economic error, and the possibility for ethical asymmetry which increases this involuntary dimension. In an embodiment of the present invention, the system can address this dichotomy both in the private oilfields in North America and the malinvestment created by government ownership of energy assets abroad.

Effectively functioning energy assets are driven by timely capitalization, discreet geologic and legal due diligence, rigorous and precise value chain execution management, and effective and timely vendor deliveries. The combination of these factors can very meaningfully lift the long-term asset performance. The complexity of the processes involved in each one of these value chain domains require multiple untrusting parties to each provide costly human expertise and expensive IT overhead. But, these processes often stick to archaic, pre-digital procedures or remain attached to siloed, unintegrated data sources. The potential for programmable business processes to alleviate these challenges and fill these value chain and information gaps can return hundreds of millions or billions of dollars to the table by preventing lost revenues and opportunity costs, or even outright costs made with unnecessarily imperfect information.

Transparency and risk diversification: Operator trustworthiness: energy operators, early stage especially, are both prone to over-representation of their prospects, and have sometimes historically demonstrated questionable ethics. The need for industry expertise in this sector of the market will not become obsolete. But due to accredited investor rules and institutional funding gaps, the normal investor in independent projects smaller than $25M often does not have the financial bandwidth to diversify risks across the same large swath of operators and projects enjoyed by professional energy investors with great analytical resources and expertise. The problem can continue up the project-size hierarchy. There are few direct methods for investors to modulate risk exposure below this lower threshold while still enjoying high degrees of transparency, industry expertise and meaningful surety in operator trustworthiness, let alone with as much direct access to ground-level projects.

Operator capital access; legal work burdens: The SEC-registration process for securitized interests in independent energy projects is very expensive and time consuming. Energy, like many other sectors, is subsumed under the modern “paperwork crisis” created by Dodd-Frank, post-2008 risk-aversion, and general global credit market fragility, in addition to the density of energy capital market conventions. Hundreds of millions of dollars are spent annually creating contracts and maintaining and managing the duplicated records for each investor and operator about the same energy projects. These contract terms likewise are often unnecessarily specific to individual projects, where standardized agreements would provide more efficiency. Moreover, the same information about a project is recorded multiple times across multiple parties where no method exists for genuinely centralizing this information. Large arrays of professionals are required to ensure that these disparate records agree with each other, are correctly updated and in synchrony and address the issues when they do not.

Capital allocator insufficiency: Every oil and gas transaction feeds dozens of mouths not involved in the risk taking or the grit-driven work of producing hydrocarbons. While the role of private equity gatekeepers is ostensibly to prevent scarce capital from being allocated to unworthy, low-quality operators and projects, energy markets are still plagued with bankruptcies, irresponsibly aggressive credit extension, and hot money flows, which create hundreds of millions in annual losses. Instead, most private allocators simply provide introduction fees to the market, buttressed by accredited investor rules. They are often more rent-seeking than value-apportioning. Conversely, these capital allocators may also deliberately make capital difficult to access for operators, and profits inaccessible to average investors whose only further exposure avenues are individual, highly speculative listed junior oil producers or zombie-like ETFs. They prevent individual investor management risk decisions by holding hostage the investors' capacity to acutely modulate their exposure, while not adding the severe judicious risk-management acumen for which they are paid.

In the lower middle market, in particular, they are not necessarily helpful in risk management, while still perpetuating the capital access and development challenges for otherwise high-quality teams and projects, and they likewise add extensive legal expenses under the guise of protecting “the little guy” investor; all while not providing genuine investor protection from the great excesses to which commodity markets are already prone. Market entrants are paying far more than they're getting.

Workflow fragmentation: For operators developing projects in the field, a complex scheme of interdependent work generated by many independent parties is required. Often, invoices from these contractors are over-billed, delivered weeks late after all cash is spent, or work is not performed. Vendors bill some operators vastly more than others, exploiting less sophisticated operators and therefore layering in risk for investors and raising capital costs. Breakdowns in these interdependent work and supply-chain events often results on large cost-overruns which force operators to dilute investors and go out searching for more capital at unfavorable terms.

Vendor leverage, workflow and margins: Contract vendors require both the ability to lower financial leverage, increase margins of safety and deliver enhanced competitiveness.

Oilfield services business, small and large, must often wait a matter of months to be paid after invoices are complete. As a result, these firms often carry the cost of energy development on behalf of operators and their investors. Furthermore, margins on services are generally tighter than in other fields, and firms carry high amounts of operating leverage in the form of assets which are very expensive relative to their billable rates. Vendors will thus also finance oilfield equipment with debt when possible. Consequently, these contract vendors are both highly financially and operationally leveraged in an industry already driven by cyclical commodity prices. Downturns often cause major disruptions in the ability of vendors to deliver services. As markets recover, the supply of oil services can often remain tight for years, causing long delays, inability of investors and operators to quickly capitalize, and more stringent contract terms. Alternatively, vendors which emerge successfully from downturns often operate on tighter budgets and must be significantly more competitive in delivery speed and execution accuracy. Yet they still lack a unified tool to reduce leverage and risk and enhance their ability to deliver.

Some further objective of embodiments of the present invention include: 1) To facilitate tens of thousands of currency holders to invest in thousands of independent hydrocarbon development project; and 2) To create a fare-free architecture for payments, data and finance by maintaining transparency, trust, accountability and risk exposure management.

The system is to oil and gas development what algorithmic trading did for commodity and stock exchanges. It provides an ecosystem of remote, self-managed, decentralized capitalization, value chain delivery, asset provenance, and immutable user credentials and “credit” system, which all users can access and trust. The right combination of cutting-edge technologies architected on blockchain applications will transform energy capitalization forever. This blockchain architecture can enhance and improve, if not even ultimately replace, the work of existing institutions of trust and competence upon which the energy industry has relied for nearly a century.

In an embodiment of the present invention, the system can include a distributed autonomous organization where mutually-distrusting parties can maintain a shared database about all the details of every ecosystem energy development, while engaging in the risks of exploratory energy development, and aggregating the dimensions of these projects into a single tradable instrument deriving its value from the production volumes to which currency holders are legally entitled. It leverages tokenized assets and multi-signature smart contracts, which does not put oilfield operations data in the consensus layer, and binds these tokenized assets to a liquid, tradable cryptocurrency. This divides the proof-of-stake features and proof-of-transaction/work features into two separate, interchangeable cryptographic media while facilitating both asset titles, transaction history and liquidity.

Preferably, this protocol is uniquely well suited to the narrow problems independent energy developers and their investors face and something adapted to the practical reality that the industry is regulated, many rules simply aren't going to change overnight, and that it perennially involves legitimate risk-taking to be successful. The system according to an embodiment of the present invention preferably functions as the template for running automated working interest and royalty interest contracts, while facilitating a fungible, tokenized interest in the aggregated profits and risks in energy development.

To that end, the system according to an embodiment of the present invention is an architecture of logical protocols which bolster and incentivize trustworthy operators' inclusion in the platform without forcing an unaffordable high degree of individual investor commitment or industry acumen.

In an embodiment of the present invention, the system represents a revolution in energy capital markets and de-risks energy investing by decentralizing investment intelligence governance, while improving the alignment between service providers, operators and investors. Through decentralization, the system in an embodiment of the present invention ameliorates the sharp need for gatekeepers while simultaneously increasing investment intelligence and governance beyond the scope of one small team of capital allocators. Smart contracts and asset tokenization rooted in industry best-practices, incentivized, merit-based proxy voting resting on immutable reputation credentials and trustworthiness metrics, proof-of-oilfield-work, rapid service provider payments, project exposure thresholds, and data aggregation all contribute to de-risking the investment process, and conspire to deliver currency holders to the highest-quality energy projects. It allows distributed investment decision-making which favors demonstrated industry expertise and performance. It incentivizes, vs. dis-incentivizes, operator and service company trustworthiness.

The system of an embodiment of the present invention facilitates rigorous authentication and superior liquidity in an opaque market up and down the upstream ecosystem. The system's market logic is geared toward ensuring the currency value is driven by growth in production volumes and not commodity prices. Information asymmetry and trustworthiness are barriers for investors, which increases capital costs for operators. Strong project analysis is also challenging. Therefore, private capital pools with meaningful analytical resources can charge very high cost for capital access to already cash-strapped operators. These capital costs can be driven down through a decentralized, trustless, global risk analytics architecture which incentivizes trustworthiness and participation, aides in risk-mitigation and capital management, forces transparency, and compresses portfolio management concerns held by individual capital pools.

The system of an embodiment of the present invention offers a computationally universal instrument to drive transparency in an often opaque industry. It facilitates, verifies, and negotiates or enforces contracts between all independent operators and all distributed currency holders. In an embodiment of the present invention, the system generates a market capitalization which reflects the surplus of energy dollars produced minus the sum of development costs across all energy projects.

Decentralization—the wisdom of crowds: The system of an embodiment of the present invention provides decentralization. The greater the distance between the frontier of knowledge and the locus of a given decision, the greater the risk and cost of information. The system of an embodiment of the present invention brings this distance down to centimeters. By shifting the locus of discretion as close as possible to the knowledge frontier, embodiments of the present invention aim to condense risk and information cost, while creating monetary incentives to elevate individual custodians' stewardship of the capital value of the ecosystem.

In most of the world, oil production is centrally planned. Even in private-property-based oil markets, relatively few firms drive production and development decision making and major firms are highly prone to regulatory capture and even deep capture. But, information and decision-making is expensive to centralize. Large groups of incentivized users are smarter than an elite few, no matter how brilliant. Dispersed, disassociated groups are better at solving problems, fostering innovation and development, coming to wise decisions, and predicting the future. In an embodiment of the present invention, the system is preferably a self-organizing system which, through decentralizing the investment allocation process, builds better rules and better managers to survive through an unforgiving selection process. There are four elements of a wise crowd: diversity of analysis, independence, decentralization, and aggregation.

Energy capital allocators are all in some way in the business of “since you can't trust each other you need us”. An embodiment of the present invention empowers users to share knowledge and cooperate, even when at the knowledge frontier. Central to the mechanism of lowering capital costs and speeding up funding is the process of liberating the wisdom scattered throughout the crowd of energy decision makers, but which no one actor possesses. In an embodiment of the present invention, the system seeks to radically drop collaboration costs by credentialing every operator, vendor and investor into an immutable ecosystem of transparency and authenticity where user identity serves to enhance or diminish users' influence over the system's capital. In this way, the system preferably disintermediates central firms and automates enforcement of key funding and transaction activities. Oilfield business relationships have the tendency to be short term and can at times be predatory. In an embodiment of the present invention, the system allows for better governance of counterparty relationships without centralization, and thereby helps build stronger transactions and helps users of the ecosystem to become more resilient and profitable. By combining human capital with financial capital in a decentralized way, the system generates better capital allocation decisions, which in turn filters into the network effects of a growing market capitalization and broader adoption.

While legacy systems have worked well enough in select legal regimes which offer staunch private property records and protections, they still suffer from inherent problems such as the principal-agent dilemma, scalability and information dis-integrity. The cost of intermediation of energy development projects significantly increases transaction costs, limiting minimum transactions sizes as well as relegating smaller projects which may otherwise be high quality to the bin of subprime. Funding behaviors tend to be pro-cyclical as well, meaning that often less discipline in project selection and execution occurs in periods of high commodity prices. Furthermore, the increasing plethora of technologies to support marginal production increases at the wellhead evidences that industry economics are not as robust as they once were, absent special developments in credit markets, and risk-return dynamics in the industry are also therefore less well-balanced.

In an embodiment of the present invention, the system provides a solution to these structural supply chain accounting and financing issues which lowers risk profiles, deploys capital in smarter and more scalable ways, provides supply chain trust, and allows embedded project economics to change. By providing an electronic payment system based on cryptographic proof of oilfield work performed and volumes produced, instead of on local counterparty trust, capital formation premiums may fall. Utilizing immutable distributed ledgers to credential users and projects in highly detailed ways integrates information for better investment governance and operator execution. Moreover, escrow mechanisms can protect and align counterparty interests without introducing transactional friction. Finally, the chain of digital signatures and real-world hydrocarbon production volumes can be defined in a single, monetizable electronic coin which serves as a decentralized, lower-cost, liquid capital pool.

Billions of people around the planet have resources that cannot easily be transformed into productive capital. Until now, no mechanism has existed which is scalable enough to bridge hundreds of millions of accounts across political and regulatory boundaries and be directed into the oilfield. By providing an agora-like platform with fixed risk tolerances and metes and bounds, and with transparent risk adjudication, in an embodiment of the present invention, the system provides that mechanism of hydrocarbon-based trust.

Energy exploration firm function: For operators, in an embodiment of the present invention, the system functions similarly to a distributed investment bank where analysis and project greenlighting are done by the distributed, merit-based proxy votes of token holders, where energy developers can access development capital for their projects. Furthermore, figuratively, in the process of distributing oilfield profits to original investors, operators may be obliged to buy partnership interests in this “bank” on public markets pursuant to the agreed upon net revenue interest stipulations.

In an embodiment of the present invention, individual operators must first attain a ranking within the system network, based on rigorous criteria. The system's sophisticated internal algorithm derives a risk score for the entire project partly based on the combined rankings of the individual operators' rankings on the project, as well as other dimensions discussed later.

Second, operators enter extensive details of their energy projects into the system's user portal, including existing production, offset well flow rates, age, well type, basin, jurisdiction, etc. These details populate the asset-backed token that operators will eventually create when project funding is approved by the system DAO.

The oil and gas industry thrives on reputations which often take a generation to build. Good reputations allow better investment terms, more security in capital, and higher rates. In an embodiment, with the system's ability to credential and create more unified and higher quality identities for users in the field, the platform gives users an advantage to fast-track and leverage high-quality work performed to build stronger reputations faster, and house them in immutable ledgers, which translates into more business, faster funding, and lower capital costs.

These risk criteria add to the dimension of the project's rank in the risk spectrum. Furthermore, the operator must select a parameter of working/royalty interest, including profit sharing parameters. This data informs the ranking logic and potential payout dynamics the operator must deliver back into the currency market, to derive an ultimate risk score to aid voters in their proxy votes. The network has a total risk budget, for which the market has a fixed capital budget. If the market has reached its risk budget, greenlighted projects are put in the queue. In one embodiment, operators must post cryptocurrency collateral for a certain amount of oilfield development work, determined by a subset of the initial drilling activity proposed. This collateral also goes to rewarding voters to cast proxy votes, and toward insurance.

Internal economic solutions: In an embodiment, while the possibility for sharp bullish price moves is understood, operators' internal economics are still under pressure. The owner-operator model of bringing great amounts of core competence in-house may prove to add less value than expected by investors in a yield-starved investment climate. In an embodiment of the present invention, the system aims to fill the gap by allowing operators to form partnerships with superior companies and build their own localized ecosystems of expertise, to reduce overhead while still maintaining a high degree of quality and execution control. By allowing operators to be more agile and flexible in the face of market cyclicality and volatility, the system platform will allow operators to offer more competitive investment terms as well, benefitting currency token holders.

Assisting independent operators and vendors toward greater flexibility and agility also allows users to future-proof their operations by focusing more on core competencies, which can translate into lower financial leverage and higher net margins. The capacity of the system's platforms to generate greater user competitiveness may also shelter token values from protracted drawdowns—a central tool in business sustainability during cyclical downswings.

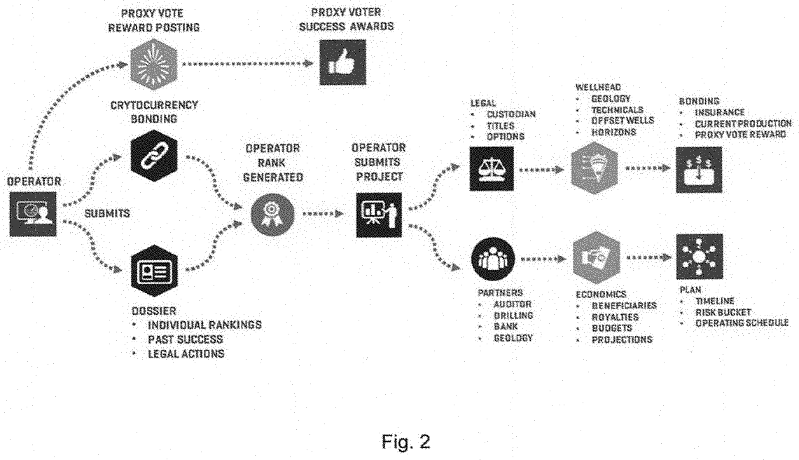

As illustrated by FIG. 2, once the operator's submission and application are complete, the DAO offers a proxy vote in which all staked currency holders which have opted to become users/members will be eligible to greenlight or reject the project. If rejected, the operators may post more collateral, change the team members and service providers, or perform other operations, in an effort to raise the overall ranking of the project, or add already-producing offset wells, for example, in an effort to lower the risk profile and then resubmit the application again. If rejected in this manner a predetermined number of times, which can include for example, three times, the project is preferably permanently banned, and the operators receive downgrades in their rank. In an embodiment of the invention, to save costs and increase transparency, working interest security teams and provisions are optionally provided to the operator in the process of tokenization. They include geology, geoposition, service providers, financials, etc., and a risk ranking, all or any of which can optionally be recorded in the system's distributed ledger tokenization for all currency holder members to view.

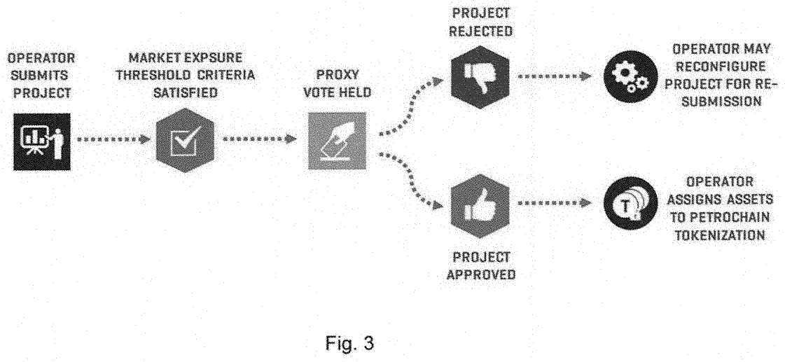

As illustrated in FIG. 3, if the project is approved, operator teams can optionally pledge their working interests, properties, titles, options, etc., into the legal custody of a system-nominated custodian and the assets are tokenized and ownership can be transferred into the token itself. The cryptocurrency can optionally be the fractional title holder of all tokenized assets of a given resource, e.g., all tokenized hydrocarbon assets.

As the currency becomes the legal claim to proceeds and/or liquidation value of the properties to be developed, currency owners then gain risk exposure to the operator's project, in addition to other approval projects. In this sense, the currency can be both a security and a project selection utility.

The individual token preferably functions as a proxy for Securities and Exchange Commission (“SEC”) or other countries' or states' securities registrations. By registering the token itself as a security and the legal custodian of all working and royalty interests posted to the organization's blockchain, exploration firms benefit from a form of pre-registration, conforming to the system's standardized working and royalty interest logic and saving them costly legal fees to individually list projects.

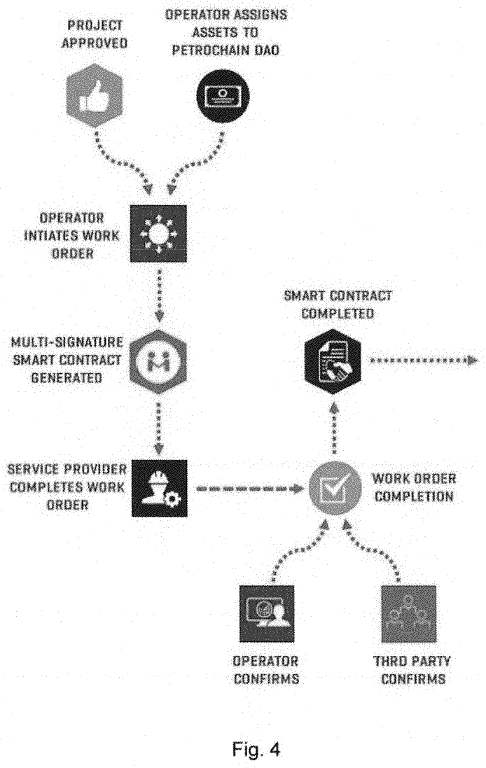

As illustrated in FIG. 4, as operators' projects are approved, and working/royalty interests' assignments are made into a tokenized asset, operators are preferably extended a currency budget determined by the development plan defined in the token's smart contracts. Preferably, this budget is then afforded to the operator to initiate multi-signature smart contracts to service providers for oilfield work. In one embodiment, no currency is given directly to operators and each party to the contract preferably deposits cryptocurrency funds into a double-deposit escrow which is preferably only released when the multi-signature smart work order contract is satisfied. When service providers have fulfilled their work orders, and operators and third-party verifiers confirm the work is complete, the smart contract preferably issues new currency directly to the service provider as payment. Simultaneously, a liability can optionally be assigned to the asset's token requiring the operator to purchase from the secondary market to the fiat currency-equivalent amount of currency charged by the service provider for each work order.

Because budgets for oilfield work can be organized as a “pay-go” function, which autonomously generates proof-of-delivery, proof-of-drilling, proof-of-production, proof-of-time, audited cash flows from the originally-nominated downstream buyers, and others as relevant, and the work can be verified on an incremental basis as development activities are completed, operators can raise far less initial capital than needed for a mature drilling program, without fear of insufficient ultimate total capital access.

Thereafter, incremental currency funds are preferably released to service providers for new work orders, and operators accrue increased currency liabilities. In one embodiment of the present invention, failure to deliver on the time series of work proofs that proceeds are deployed for their mandated use can trigger a class action lawsuit and SEC action against the non-compliant operators and service providers on behalf of all currency holders, investors and other operators, as well as forfeiture and liquidation of the operator's assets.

According to an embodiment of the present invention, as operators obtain oil production revenues, operators also owe delivery of net revenue interest to the system DAO as determined by the asset's standardized contract. Operators can be obliged to buy currency from the secondary market. Optionally, the liability assigned to the operator's token dictates that the first purchases of the currency will be burned/destroyed until the entire liability for oilfield work is retired. This neutralizes the increased supply of the currency created to originally pay service providers.

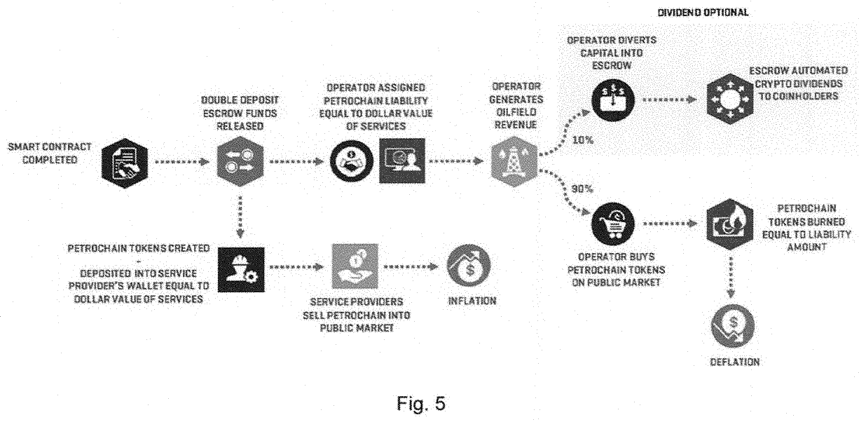

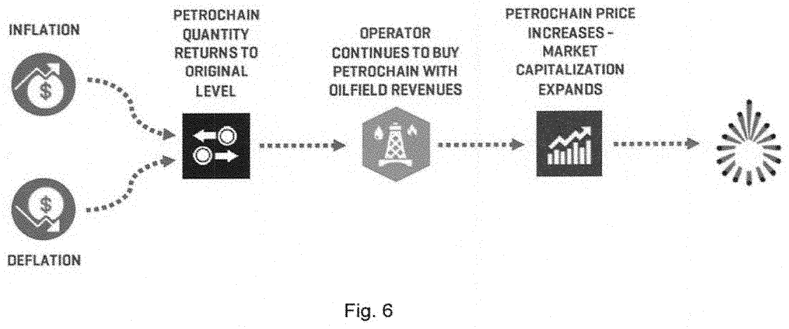

As illustrated by FIGS. 5 and 6, as the liability is retired, operators then preferably continue buying currency pursuant to the net revenue interest owned by the system DAO. In one embodiment of the present invention, e.g., when functioning within the United States, these buybacks can optionally constitute expenses against which taxes can be written. Any outside investors in the operator's project can also optionally disclose these repurchases as wellhead expenses pursuant to conventional tax advantages. A pro rata share of write-offs inures to each system member, predicated on average annual coin holdings. In addition, the system can tokenize these taxes and make them tradable within the ecosystem.

Operators then begin to accumulate large amounts of currency which may be liquidated at a maximum of one third of total holdings per month, ensuring operators do not create large spikes in the currency exchange rate. Furthermore, decreasing the currency supply and adding fiat currency purchases to the market supports an ongoing liquid market bid for currency.

However, the unliquidated currency can, during this mandated holding period, be exchanged for more oilfield work without adding to the operator's liability. This allows the operator to rotate oilfield revenues back into new wells without needing to initiate a new proxy vote event or add new project risk into the system's risk budget and exposure threshold as long as the subsequent oilfield work is only applied to wells belonging to the originally-tokenized asset, and oilfield work history is imputed into the token's history. Additionally, the currency acquired during the net revenue interest repurchase can be used as collateral which can increase the rank of any subsequent project the operator submits for a new proxy vote. This continuous fiat currency bid for currency rewards owners of the currency with market cap expansion and an increase in the exchange rate and ties the market capitalization to total wellhead profits. To prevent currency “borrowers”, those raising funds by pledging working interest securities to the blockchain, from being short on the currency itself, they are preferably obligated to repurchase an exemplary US dollar amount of the system at the market price at the point of cash flow delivery, not a coin-denominated figure. This also ensures that widespread adoption and project profitability, not short covering, drives the currency value.

In one embodiment, to promote currency coin staking and adoption, the operator can optionally divert a minor percentage of oilfield proceeds into an escrow account owned by the system DAO. As funds in this escrow account increase beyond a predetermined percentage, for example beyond 10% of the market capitalization of the currency, an equivalent amount, for example 10% of the escrow account can be converted, preferably annually into a secondary high market capitalization cryptocurrency (e.g. Ethereum, Bitcoin, Litecoin, etc.) and can preferably be distributed as an airdrop to all currency holders as a monthly dividend.

In one embodiment, the system's DAO membership can preferably be established through the purchase of currency, the pledging of that currency to an escrow account, and the submission of a detailed member profile which begins the member's reputation and ranking. Members must demonstrate a legitimate economic interest to participate in proxy votes which can be lost should the member consistently choose poorly performing energy projects. Membership may preferably be required for all would-be voters, service providers and operators.

System members benefit from exposure to the distributed, merit-based, incentivized proxy voting for managing risk exposure to operators, well types, teams and geographies, e.g., proxy voting, through holding currency as market capitalization expansion drives a rising exchange rate. Upon operator project application which meets the basic industry best-practices requirements, DAO members are preferably incentivized to vote correctly—applying industry expertise to select successful projects. Voters build network credibility through successful project selection. In one embodiment, as a voting member who consistently votes on projects which are ultimately successful, the voter can optionally receive a disproportionate share of the operator's voter incentive bonding.

Additionally, the successful voter's rank increases, further increasing voting power in subsequent proxy votes and thus garnering greater rewards from subsequently successful votes. This incentivization can create greater success rates in the proxy voting system, and potentially to develop a body of members who dedicate time and intellectual capital exclusively to voting correctly. In one embodiment of the present invention, as the currency market capitalization grows large, the reward for successful voting grows sufficiently such that individual member voters could make a living exclusively through voting activity. Highly ranked, large token holders who earn through voting will become like investment intelligence nodes unto themselves, as other member voters observe their votes and vote alongside them. While the ability to bandwagon will dilute rewards to successful voters, it will also disincentivize these “voter nodes” to select low risk projects, in turn spurring the potential for selection of projects with higher but potentially riskier returns.

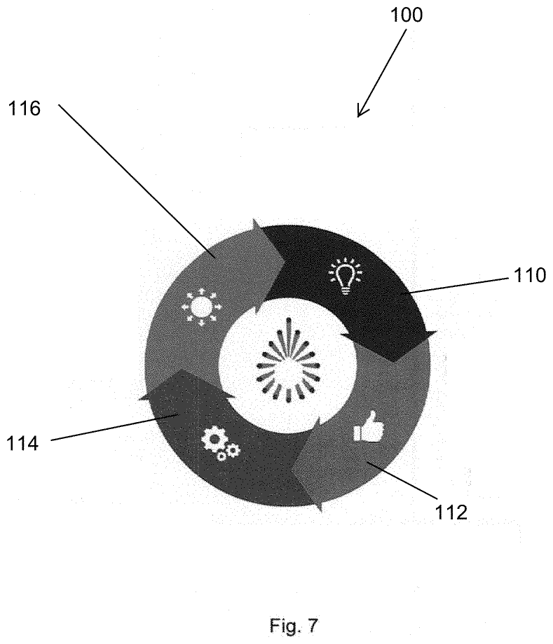

In one embodiment of the invention, the system/ecosystem/platform integrity stands on six pillars: working interest and/or royalty interest submissions, ranking, project size, member bonding, proxy votes, and legal recourse. In an embodiment, operators are preferably required to go through rigorous logic procedures in submitting projects for capital access, wherein if these procedures are defrauded, court-based legal recourse can be triggered. This process overview is illustrated in FIG. 7.

As illustrated in FIG. 7, process 100 preferably involves proposal 110, wherein bond operators can submit energy project proposals. The proposals preferably define one or more of geology, service providers, operating team, legal compliance, economics, and/or development plan. Operators offer to assign their properties/rights to a unique PetroChain token owned by PetroChain DAO currency holders. And the project is preferably assigned a risk score. Then, proxy vote 112 takes place wherein PetroChain coin holders vote to approve or disapprove a project. The voting power is preferably driven by voting reputation, track record, and total holdings. Based on the project's risk score and the available capital budget, the project is apportioned a fixed amount of total risk capital. After proxy vote 112, development 114 preferably occurs. In development 114, multi-signature smart contracts preferably drive workflow of approved projects. Service providers are preferably paid directly in PetroChain, and matching liability accrues to the operator. The project can be funded in installments, leveraging initial capital pledged by operators, maintaining a mutualistic market—operator relationship. Finally, development 116 preferably takes place, wherein operators buy PetroChain on the secondary market with proceeds from successful drilling. They first retire their service provider liabilities, then apportion remaining proceeds. Revenue sharing between operator and DAO is preferably driven by PetroChain's standardized working/royalty interest agreements. Coin value preferably rises as excess oilfield proceeds are used to buy PetroChain.

Working interest/royalty interest submissions: In one embodiment, for operators to access the system's capital, they preferably subscribe to basic working interest securities conventions by tokenizing their assets, binding themselves to perform on the tokens smart contracts in lieu of a physical paper contract, but with no less legal standing. In an embodiment, the objective is that the contract will be more rigorous than a conventional paper contract, especially due to radically increased scrutiny across a large voting population. Contract standardization will preferably help operators to achieve greater speed to market and save on costly legal documentation. The standardized format, which will preferably include multiple configurations operators may choose, can also work to head-off the operator's incentive to dipping into project funds to pad their own salaries, and divert risk onto unsuspecting investors. Standardization creates optimization and transparency. Each token may preferably have its own asset custodian which holds paper titles on behalf of the DAO, directed and nominated by the network in the event of necessary liquidation.

In one embodiment, working interest submissions can also include rigorous information requirements. Information includes drilling and other service contractors, materials providers, auditors, downstream buyers, clearing banks, attorneys, geologists, combinations thereof and the like. all of which must preferably also submit confirmations for engagement and be DAO members. In one embodiment, operator rank can be influenced by the rank of each of the service providers engaged on a project. When transactions are completed, the rank of the counterparty service provider is preferably factored into the ranking of the operator. This helps incentivize operators to choose highly ranked vendors in order to access greater capital funding in later projects, which in turn incentivize service providers to execute more ethically and with fewer mistakes and delays. Over time, operator rankings can be meaningfully influenced by their judgment in and successful cooperation with other successful sub-contractors/vendors. Because there is a compounding effect in this component of the ranking, a winner-take-all dynamic emerges to allow consistently successful operators to get increasingly greater approvals for capital and more favorable funding terms. In turn, by ensuring over time that sound execution is a general feature of the DAO, the portfolio is de-risked and the earnings multiple afforded the token are proportionally higher, allowing for even greater funding possibilities and even lower insurance premiums. This helps the network achieve greater compound growth than a centralized, single-team-managed energy capital pool and retain greater share of purchasing power for at-risk investors than is available in a traditional private equity model. Each service provider preferably has their own rank in the network. Subsequently, landowners are optionally be able to execute option contracts with operators through protocols. The characteristics for greenlighted projects, and the following information can be included in the ecosystem, asset tokens, and subsequently organized smart contracts:
Detailed financial and asset data including proforma lease acquisitions, a drilling flight plan, new areas/markets for expansion and/or new products;
Dossier details of key managers;
Track record—for exploration and production (“E&P”) companies the well drilling history is important; for service companies results from past and present business initiatives should be outlined;
Detailed financial proforma with reasonable assumptions that reconciles with the overall business plan;
Science and lease maps showing proved developed producing (“PDP”), proved undeveloped (“PUD”), and/or other drill sites, leases with other operators and nearby pipelines and other transportation;
For service companies, revenue and profitability by customer and by product category over a two to three year period; customer lists detailing the top ten customers, and lists of accounts payable;
Corporate records and historical financial statements that are organized and complete; and
The company or management team can be required to pledge collateral in the form of the currency of the system, cryptocurrency, or pledge leases, PDPs, PUDs, working interests, company assets, or equity assets which can be tokenized in order to align interests of management and the coinholders.

Submissions can also include data on technical geology, geographic coordinates of each well site, offset well data, and data on target horizons. The entire chain of economic beneficiaries is preferably also included, such that the system's logic can locate conflicts of interest. Such conflicts can either raise the project's risk ranking or disqualify it altogether.

User identity and ranking: Extensive application of game theory to the DAO's user ecosystem buttresses superior investment allocation decisions. In one embodiment, identities of all users including operators are preferably known by all other users for investment governance to be performed well. Furthermore, caps on the system's exposure to any individual operator or operator's projects are preferably be maintained. Each tokenized asset is therefore preferably prescribed with the data of each of the individual project participants. Members of the system are therefore preferably subject to a sophisticated reputation system, based on the type of user. The operator ranking system houses data on each individual which participates in a project submitted to the DAO.

An individual's operator rank is preferably determined by a host of algorithmically organized factors that can include one or more of the following:
Lifetime fiat/crypto returns delivered to the system currency;
Average project return on investment (“ROI”)/Average ROI per well;
Field and well success rate (natural gas, oil, quality, water, etc.);
Average project size;
Average ranking of historic team and service provider associations;
Degree of historic delays in working interest payments;
Historic/pending litigation and lawsuit size;
Basic information: photographs, address, SSN, driver's license, etc.;
Highly ranked operators certifying/sponsoring a new, un-ranked operator (sponsor's failure negatively affects sponsor's rank); and
Management's ability to extract hydrocarbons from an area where others are unsuccessful; ability to lease large chunks of land in high demand areas; a proprietary technology in high demand by the market.

In an embodiment, when operators assemble teams, each team member's individual reputation score can populate into the projects score, which then determines its viability and its maximum funding allocation. Operators preferably assemble teams with aggregate reputations above a certain level to submit their project for consideration.

Risk factor points: In one embodiment, the system preferably consistently maintains a dynamic risk exposure budget measured by the average scores of the projects greenlighted and added into the network minus the degree of initial risk exposure of those projects already returned into the system DAO. Preferably, this budget is measured in risk points. As these projects begin to deliver returns, and therefore purchase currency on secondary markets, the project risk decreases. Preferably, as a result, the system is dynamically less at risk, which frees risk points to be made available for new projects. After some return threshold is reached, the system platform preferably has enough risk points available again to allocate to additional projects. In an embodiment, those previously greenlighted, but for which insufficient risk budget is available, are put in a queue. Because commodity markets can change rapidly, such as within the time a project is approved and when the system's risk budget is finally freed for the project, a secondary confirmation vote can optionally take place as the project reaches the top of the queue. When a project reaches the top, a non-incentivized vote preferably again takes place to confirm the project's approved status. This then deducts again from the system's available risk points budget.

These risk measurements determine the ultimate amount of exposure or project size an individual or individual's team may add to the system, or the amount of currency released at one time for a single project's development. Ultimately, a subjective choice is preferably made about how much volatility to allow into the currency platform without constraining growth potential.

In an embodiment, the DAO's total risk point budget is the percentage of market capitalization which could be lost at any time through the coordinated failures of every greenlighted project to which capital has been issued, but not yet producing. Allowing for a 25% loss from such coordinated failures, 50 basis points in current risk per project can represent 47 or more coordinated failing projects.

Voting: In addition to the risk ranking held by operators and service providers, in one embodiment, every member preferably has a voting rank. Voters can increase their proxy voting merit amount through successful project selection. Greater proxy voting merit can optionally increase the proportional share of rewards from successful votes. As described below, in one embodiment, these rewards are preferably supplied by an operator's project voting collateral posted divided by total successful votes multiplied by a merit factor of the user's risk ranking. In this embodiment, each voter preferably achieves a proportion of the weighted average of the total votes based on quantity of currency owned (up to a maximum threshold) and the performance of projects they have historically supported.

In one embodiment, an operator's rank can influence the risk classification bucket into which his project falls, which in turn is preferably fitted into numerically-defined project classification, each of which is assigned a standardized number of risk points. These points are preferably then compared against the limited number of risk points available to be extended to a new project at any one time.

Well minders: In an embodiment of the present invention, all operators' ranking data preferably shows the actual wells they have completed, such that randomized physical investigation is possible. Other non-operator individuals can also optionally earn currency by acting as well-minders. Each of these minders can also optionally earn a ranking to establish credibility in their certifications of well activity. In one embodiment, well minders can register and stake themselves with crypto and/or currency. For each project, minders are preferably chosen at random based on location, and their expenses are covered by operator's initial project bonding capital. Additionally, remote well monitoring hardware/software can be required for any system working interest transaction to integrate production performance and auditing onto the blockchain and into the DAO dashboards.

Service providers: In an embodiment, to validate system membership and generate a ranking, service providers preferably also create a cryptocurrency bond of their own, held in escrow. As operator service contractors gain ranking through successful work deliveries and participation in successful projects, their ranking increases and they become more sought-after by operators to increase the probability of success in winning proxy votes.

For new system DAO members, on-demand, blockchain-based identity verification implemented by civic can be included to prevent anonymous new users from impersonating others and issuing working interest liabilities on their behalf.

Project size: Based on currency market capitalization, in one embodiment, projects preferably have maximum size thresholds. The market capitalization can determine the maximum size a single project accessing the platform can be to be approved, establishing a project exposure threshold which prevents a single project failure or fraud from disrupting market integrity.

Gearing: As market capitalization grows, so too will project size budgets. In an embodiment, individual operators cannot access more than $25M in net development capital until the market capitalization increases beyond $5B. But this $25M will be only the initial threshold. At the system's launch, because the market will be staked initially by only five or six exploration projects with a combined market cap of ˜$50M, the system's per-project exposure will be higher, approximately 20% to each individual project. This threshold will fall as the market capitalization grows. The larger the market, the smaller the percentage of total capital accessible, but the larger the project size.

As the market size grows, the total exposure to any single new project will fall smoothly, optionally driven by a pre-programmed calculus, and will preferably have gearing to the downside. Thus, volatility in the market will not be usable as a tool to manipulate the markets risk exposure threshold. Should the market grow, then shrink sharply, the initial decrease in the exposure threshold will not be fully retraced by the degree to which the market size subsequently shrank. For example, initially the market size rises from $50M to $100M. The market capitalization increase creates a gradual decrease in the single project exposure threshold from 20% exposure down to 10%. Should the market then shrink back to $50M, the exposure limit may only rise back to about 15%. The precise downside gearing can be determined in the development process based on calculations deemed most flexible and most positively affecting market integrity.

In one embodiment, an algorithm preferably optimizes the tradeoff between currency secondary market behavior and in-field utility and provides the flexibility to alter these thresholds based on a proxy vote among the system's DAO members.

Risk exposure: The system logic preferably accommodates projects of varying risk profiles, from the liquidation of a royalty interest with several years of production history to greenfields exploration project. Therefore, the market preferably also has a limit for how many riskier projects it will allow to pass through to the proxy voting stage. Likewise, the protocol preferably accommodates the variances posed by jurisdictions outside North America in what constitutes an energy exploration interest.

The capital market risk allocation governor preferably applies to projects arranged into risk classifications with discreet and transparent qualifying features. Which classification a project falls into can vary based on one or more known criteria including but not limited to: operating team rank, geography rank (if any), production history (if any), asset mix/current production pledged, the type of payout contract selected/net revenue interest terms, automatically-assigned risk factor points.

In an embodiment, the system DAO as a whole can have a limited budget of risk factor points available to be greenlighted at any one time. Legacy established overriding royalties can represent a high score, while new fields, new operators, no offsetting production, etc. can carry a low score.

Because it is possible that proxy votes will trend toward greenlighting only conservative projects, this will disincentivize more exploratory operators from accessing the system, and could hinder market capitalization growth, as well as separate the system's value drivers from North American production growth. Therefore, operators can optionally reduce the risk factor points attributed to their projects by raising proof-of-stake bonding (by raising other capital outside the ecosystem and therefore selecting a slightly lower risk-profile contract type, for example), or bringing highly-ranked individual veterans and operating partners (including large, well-established E&Ps) into the project.

Proxy votes: In one embodiment, the objective of the proxy vote system is to create a highly distributed and well-fueled internal ecosystem populated by thousands of currency holders vying for voting rewards based on bringing superior insight and analysis. After operator submission to the system for working interest capital, the project is preferably submitted to a proxy vote by all system members. Voting logic is preferably determined based on numerous factors which can marginally influence proxy vote outcomes within a system of merit and bound economic interest. Merit and ownership are balanced to support market integrity and prevent conflicts of interest.

In general, representative democracy tends to deliver superior results to pure democracy. In one embodiment, the system preferably offers a coercion-resistant liquid democracy system which defends against manipulation, protects coin values, and maps to conventions of fairness and effectiveness of already-established, long-standing and peer-reviewed game theoretic institutions. Understanding that the system's capital allocation architecture is preferably both built to last and built to be composable (so future feature sets can be layered in as opposed to more fragile monolithic private equity and cryptographic systems) will support the system's bid to seriously dominate large swathes of the energy capital market.

Market integrity requires prevention of a strict democratic proxy voting system and therefore not subject to the manner of a 51% attack to which pure democracies are prone. Large coin holders should be unable to completely ban new operator entrants. For example, an operator in a certain basin which has acquired and held high currency amounts over years of repeated successful projects payouts will desire to vote down a new entrant into that same basin. They should not be able to command the voting power to do so unilaterally, so that the system's market exposure to the basin does not become simply a focused risk on one operating team.

However, highly ranked operators who also possess a large economic stake to qualify them to vote and who are also petitioning the system for new capital will naturally have larger proxy voting power. This incentivizes good operators to use currency in a recurring fashion. Swaying votes against new operator entrants by cornering large amounts of currency will also be very expensive compared to the maximum project exposure threshold, dis-incentivizing cartelization of proxy vote blocs from forming. Even if large proxy voting power can be cornered, the outcome of any single project itself will not benefit the operator to a greater extent than the cost of acquiring so many coins.

Moreover, because in an embodiment, operators are not incentivized to hold token amounts vastly larger than what might be required to finance an individual project (up to $25M), unless they also choose to hold betting on token appreciation, larger token holders are likely to be speculators, outside investors or even market manipulators.

In an embodiment of the present invention, large token holders which vote will also function as investment intelligence nodes. Voter nodes can tend to attract smaller voting blocs to vote alongside them to earn a share of the collateral as a voting reward. Voting quorums can optionally be achieved through a dynamic process whereby the greater the overall portfolio project exposure, the larger the quorum must be in order to both generate a vote and greenlight a new project. This quorum requirement relationship can also be nonlinear, such that incremental risk exposure added must be done with progressively more scrutiny. Likewise, this tightening effect can retract in the same fashion as previously greenlighted operators perform the required token buybacks.

In an embodiment, a proxy vote can still vote down a project of a highly-ranked operator, however, operators will have the opportunity to re-submit each project, in so much as each re-submission preferably requires changes in the makeup of the project, including increasing the overall rank of the operating team (dropping low-ranked individuals, etc.), increasing the ranking of operating partners (drillers, trucking, geologists, etc.), adding offset production or new offset well data, and increasing the cryptocurrency collateralization amounts. Logic, tied to the geographic coordinates of well sites in the original project submission, also preferably prevents operators from rebranding the same project as a separate new project. In one embodiment, new projects are preferably geographically far enough away from previously-submitted and rejected projects.

Preventing speculators from proxy votes: In an embodiment of the present invention, the system seeks to induce proxy votes to be highly informed. Coin holders can buy currency on a secondary market without being registered, and therefore ranked, in the system network itself. As voting can optionally only occur from the system held within currency-compatible wallets, speculators not interested in the system DAO membership may simply never use their system to demonstrate proof of ownership in originating a member profile. In the effort to decentralize and elevate ecosystem security, the system preferably maintains its own wallet utility. However, it preferably engages with other wallet providers to create voting and ranking functionality as well.

Ultimately, this means speculators will not vote on greenlighting new energy projects, but will also not prevent smaller currency holders from serving as proxy voting agents. Furthermore, logic is preferably provided for combining the system holding time and amount held, below which coin holders are still prevented from proxy votes. This is intended to further exclude speculators and “pump-and-dump” trading behavior—also common among independent E&P firms—used to rapidly influence proxy votes. This initial lockup to become a system DAO member will preferably be no longer than 180 days.

Voting incentives: In an embodiment, attracting highly informed voters requires incentives for the system DAO membership registration and for ranked system holders who do not rapidly trade out of the currency. Thus, more highly ranked voting members with track records of voting in-line with the success of new projects preferably receive a greater percentage of the overall rewards owing to all voters on successful projects. Likewise, there is preferably disincentive to vote for projects which ultimately fail.

First, in one embodiment, to register as a proxy voting ranked system member, ownership/bonding is preferably required. A specific amount of currency or other cryptocurrency can be required to be posted as collateral into a locked escrow wallet, not to exceed the potential rewards for successfully voting on one single project. This collateral preferably enters the overall ante available to voting participants, further incentivizing successful voting. Therefore, the amount of registration bonding preferably fluctuates based on the total amount of new voters' collateral plus the total project collateral slated for voting rewards posted by all operators, plus all excess collateral posted by large token holders seeking to become voter nodes. In this embodiment, the larger the market capitalization, the larger the member base, the larger the voting rewards, and thus the market's appetite for larger projects/larger funding allocations will grow also.

In an embodiment, as a voter's ranking falls, an amount of currency/cryptocurrency is preferably removed from their escrow account and distributed to others in the voting system as their reward for correct voting. In this embodiment, a failing proxy vote track record will both decrease the ranking and cost the voter its cryptocurrency bonding. The voter can optionally “re-ante” with a new bonding amount should the original crypto bond be depleted, but this time pursuant to his lower rank, requires a larger stake.

On the upside, a successful proxy vote track record preferably earns the voter a greater share of the voting rewards pursuant to his reputation and ownership. Reputation credentials also preferably increase as successful votes are cast. Should every voting member vote successfully for a project, this will be dilutive of rewards to each voter. However, in one embodiment, meaningful insight which is divergent from the crowd and is also correct is preferably incentivized heavily as voters accrue proportionally large rewards, preferably allowing some incentive for decisions geared to right-tail energy project outcomes.

Reward funding: In one embodiment, rewards for voting are preferably created from three streams:

1. Bonding posted by the operators seeking development capital: Because this reward payment will not be distributed to voters until the project has become net profitable, voters will tend to vote on projects with a pay-as-you-go development plan, which will likely tend to reduce market risks itself as capital is deployed in a more limited way up front.

2. Bonding posted by each voter which voted against the final outcome of the project: A “yes” vote on a project that is ultimately successful is partly rewarded by those who voted “no”. Each voter must preferably maintain a minimum cryptocurrency allowance to be a system DAO member. Cryptocurrency is preferably debited from those wallets with “no” votes and credited to those with “yes” votes, in proportion to their voting reputation and ownership stake, from the total reward funds available. Concurrently, a “yes” vote on a failing project also preferably burns some currency in the voter's wallet and decreases their voting reputation so as to make participation in future votes require greater currency staking.

3. Overriding royalties: Voters can also optionally earn exceptional voting scores over time. Above a pre-programmed threshold, a voter with high merit and ownership can optionally benefit from the overriding royalty interest set aside in each project to incentivize votes.

Voter nodes: In one embodiment, voter nodes can be formed by large currency holders with exceptional rank and high hold times also pledging significant collateral to incentivize voter rewards at large. Ultimately, these nodes are preferably formed by long-time participants who have earned their way up the ranking system, and pledged collateral in order to support investment analysis and voting logic in the long term. In this embodiment, their incentives are long-term capital appreciation in currency, and dividends/royalties in the form of successful voting rewards.

In representative democratic systems, smaller stakeholders preferably have the capacity to delegate their votes to delegates. In this embodiment, smaller system voters can elect delegates among the successful voter nodes and automatically cast votes alongside them. In one embodiment, delegate voter nodes with higher staking, higher reputation and high hold times can optionally earn a slightly disproportionate share of voting rewards based on the population of smaller coinholders which have elected them. Preferably, a rigorous analysis can be used to prescribe of the quorum which must be reached before a proxy vote is complete and a project is greenlighted.

In one embodiment, there is a clear diseconomy in being a voter node on the dividend side. As voter nodes gain in voting power and reputation, other voters mimic them, and accrue a positive externality for themselves, while also diluting voter nodes of their dividend rewards. This dilution preferably does not affect the royalty earned by the largest and most successful nodes. This diminishing marginal return to be a high-delegate voter node ensures that voter nodes cannot command a super majority.

In a large market size, however, it will likely be far more difficult to accrue outsized voting rewards. Voter nodes, in effect become a form of miner, adding to system credibility early on and acquiring the seigniorage that results. The seigniorage spread from sound voting will decrease as the currency's market capitalization grows in a manner similar to cryptocurrency mining, where minable funds per block decrease as hashing difficulty increases. The price of currency will positively correlate to greater proxy voting participation, increasing net voting rewards despite increasing competition for finite available rewards. Likewise, this increased voter reward also incentivizes more early adoption of the token both on the investment side, and therefore, on the operator side. Thus, early establishment of voter nodes by various groups speeds the appreciation of the currency.

Legal recourse; class action suits: In an embodiment, if an operator is successful in the proxy vote process, but the operator still defrauds system holders, an automatic class-action lawsuit can optionally be triggered. Advanced algorithms preferably monitor the system's greenlit projects for indications of potential fraud. For example, failure to demonstrate wellhead activity within a given time frame as demanded by the smart contract, as well as large discrepancies in stated service partners, well geographic coordinates, etc. Well activity certifiers are preferably subject to class action lawsuits should they make false certifications into the system ledger.

In one embodiment, built into the system logic is a bidding mechanism whereby attorneys listed as prospective class-action representatives within the system database are autonomously asked to bid on the class action suit services, thereby affording currency holders cost-effective representation.

Bankruptcy: As operators pledge working and royalty interests to the system, they preferably trade legal custody of these properties to the system. In one embodiment, each property title is assigned to the system and housed at a regionally prominent custodian on behalf of the system DAO which takes legal custody of the asset.

Operators will periodically face bankruptcy. In these instances, the system preferably serves as auctioneer in its own in-house auction for the assets first among coin holders. Coin holders can optionally be given first rights to bid on properties conducted through an autonomous bidding system.

If the system's ecosystem does not produce a winning bidder, all tokenized properties within the operator's project are preferably moved to an open fiat auction. Auction proceeds are preferably delivered by the auction house into the system's ecosystem and distributed to coin holders in a one-time cryptocurrency dividend.

In one embodiment, the system preferably provides a transaction architecture whereby investors can be sure that users who would seek to defraud the platform and token holders have sufficiently negative consequences such that investors can operate with high degrees of confidence about the rationality and authenticity of other actors. This includes:
Penalizing voters which select fraudulent projects through demotions and stake forfeiture;
Class action lawsuits triggered when fraud is detected with imbedded warning triggers;
Disintermediating vendors from operators in order to confirm transaction legitimacy on behalf of token holders;
Managing exposures to individual projects and teams;
Requiring operators to bond themselves to prevent free looks and other behaviors which sidestep financial stake in outcomes; and
Incentivization of randomly selected third-party project performance verification agents and IoT device integration.

Balancing risk protocols and growth: In one embodiment, the sum of market capitalization credit added through successful energy projects is preferably greater than the amount of losses on unsuccessful projects. Therefore, no one participant can issue too great an amount of working interest to disrupt the average quality of projects represented by the currency. The DAO's working interest exposure threshold is therefore preferably capped at a predetermined amount, which can include for example an amount of $25M per issuer. This lower exposure threshold can initially attract sub-optimal operators which may or may not be voted down by the proxy system. Subsequently, large numbers of down votes will both discourage new high-quality entrants and impede market capitalization growth in later years. Therefore, the specific tolerances of the protocols set at the beginning are preferably critical to balance both risk control and optimal growth. Embodiments of the present invention can preferably reach this without the use of forks or proxy votes reestablishing new protocols by preloading the ecosystem with strategically-acquired overriding royalties—in effect “buying buyers” of the currency.

According to an embodiment of the present invention, the Cardano blockchain can be used and will provide desirable results. In an alternate embodiment, other blockchain protocols are optionally employed. For embodiments employing the Cardano blockchain, the preferable characteristics of the blockchain used include a rigorous, durable, and systematic ledger protocol suite. It is preferably developed with strict attention to scientific philosophy, game theoretic and governance challenges, and integrates advanced feature sets of distributed ledger technology protocol. In terms of integrity and scalability, the system is preferably highly modular, accounting is preferably performed separately from computation, it is preferably built for DAOs, having one ledger and multiple assets. One embodiment of the knowledge frontier preferably maps to legacy conventions that brings stakeholders closer and is engineered for best practices and regulation without compromises. For ascertaining authenticity, an embodiment of the present invention further comprises an extensive academic review, is upgradable and flexible, and has interdisciplinary development.

Regarding philosophy and execution of embodiments of the present invention, critical to the functionality of the system, Cardano works to provide answers to challenges which have the potential to destroy the store-of-value nature of other protocols, such as computational bloat, necessity of hard forks, lack of economic value stratification of various running applications, modularity, even the necessity of mining over staking. Likewise, the protocols facilitate voting delegation on a large scale required for the system to achieve deep network effects. Ultimately, those protocols which most rigorously tackle the synthesis of both the technical and the moral direction of the protocol suite can be the most resilient and positively exposed to inevitable changes in specific structural details.

The developer of the Cardano protocol has pursued the industry's most objectively scientific development approach through a global peer review process which is transparent and well-documented. The development roadmap has been executed consistently and maintains the commitment of core theorists at multiple academic institutions. The resilience of the developer team contributes to the maintenance of platform integrity as protocol forks can damage the system's progress. Even Cardano's own internal development funding mechanism functions very similarly to the system of the present invention.

While Bitcoin stores a degree of metadata which supplants legacy centralized systems, the inclusion of greater depth of transactional metadata can both enhance monetary value of a token or blockchain protocol. Conversely, the counterfeiting of this data can be equally destructive to this value, and it is insufficient for industrial applications of a blockchain to deliberately exclude a capacity to house this metadata like some other blockchain protocols do. The integration of work attribution, compliance, reporting and credentialing, are equally important to functionality of the system than the exchange value of the bearer tokens. Cardano has enjoyed a greater attention for these features than other protocols since inception.

As a consequence of this attention, Cardano can help facilitate greater scalability for embodiments of the present invention, as well as support secure voting, modularity and the more complex incentivization. These embodiments of the present invention preferably leverage the use of Cardano for its investment governance and to maintain a large, dynamic user base. Ultimately, the system users and tokenholders can benefit from the freedom to change voting rules, project funding thresholds, the way in which credentials are developed and recorded, and the way asset performance is evaluated. A protocol as rooted in a clear-eyed set of operating principles can provide a robust protocol suite for growing purposes.

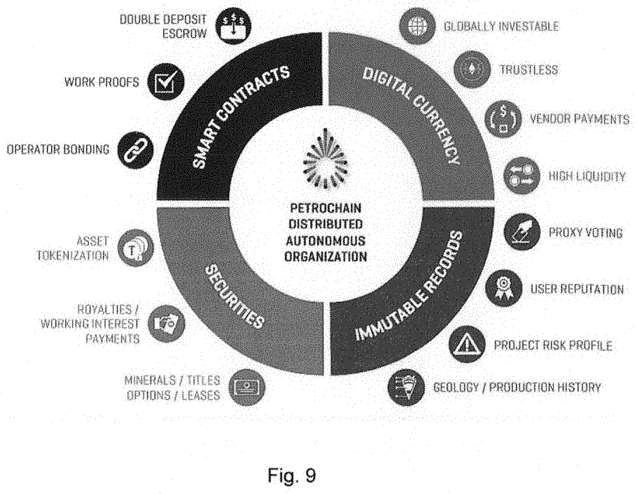

As best illustrated in FIG. 9, rather than leveraging two layers of tokens, e.g. Ethereum Request for Comment number 20 (“ERC-20”) for the currency token and Ethereum Request for Comment number 721 (“ERC-721”) for the asset token, Cardano provides the ability to break down transactions, identities and assets into multiple, decentralized settlement and calculation layers including asset tokenization itself and the currency cryptocurrency. This allows for ephemeral data such as trading transactions to be kept separate from the DAO's internal ecosystem logic, reputation systems, and asset data. While the currency will be tradable with other cryptocurrency and fiat, the underlying asset tokens are preferably tradable only for currency and locked into a single integrated system of settlement layers.

As illustrated by FIG. 9, in one embodiment of the present invention, a solution is provided through a DAO. The distributed autonomous organization preferably comprises smart contracts, digital currency, securities, and immutable records. The smart contracts preferably also comprise operator bonding, work proofs, and double deposit escrow. The digital currency can preferably be globally investable, trustless, have vendor payments, and have high liquidity. The securities preferably comprise asset tokenization, have royalties/working interest payments, and have minerals, titles, options, and leases. Immutable records for each of proxy voting, user reputation, project risk profiles, and geology/production history.

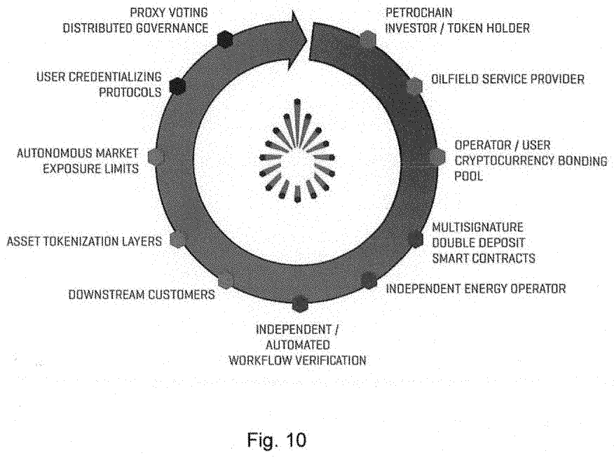

FIG. 10 illustrates an embodiment of DAO dynamics via a self-supporting funding mechanism. The dynamics preferably include a system investor or token holder, oilfield service provider, operator or user cryptocurrency bonding pool, multi-signature double deposit smart contracts, independent energy operator, independent and automated workflow verification, downstream customers, asset tokenization layers, autonomous market exposure limits, user credentialing protocols, and proxy voting distributed governance.

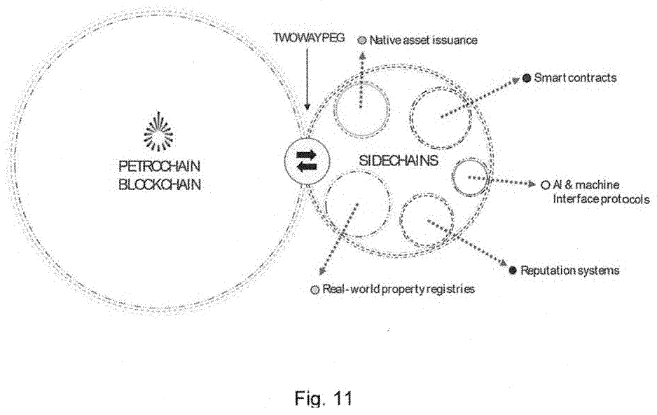

As best illustrated in FIG. 11, in one embodiment, asset tokenization and performance layers preferably function through sidechains which own much of the network logic, allowing currency to be used solely for speculation and in-field transactions while avoiding computational bloat.

In one embodiment, because the public ledger of currency transactions by itself cannot provide a one-to-one correspondence between endogenous networks and what exogenous jurisprudence says about the status of the system's financial contracts, the sidechain architecture and independent asset settlement/tokenization is preferably used to allow the network to replace legacy settlement conventions.

As public distributed ledgers, such as that used in the currency of one embodiment of the present invention's cryptocurrency, are unsuitable for securing off-chain assets, which are both legally authoritative and censorship-resistant, the use of currency and a combined sidechain architecture to represent a pseudonymous bearer asset which as entitled to the system's hydrocarbon asset portfolio is preferably required. The sidechain architecture ensures that the system DAO will remain the authoritative record of asset ownership, as well as be flexible enough to eventually add functionality for bonds, mezzanine debt and other loans and equity, in addition to the securitization of working interests and royalties. In addition, voting and user credentials and histories can be maintained in underlying sidechain tokens as well.

Unlike some protocols which prohibit opacity, Cardano allows for the flexibility for users to decide which computation should be private in nature. Uninterrupted transparency is needed for counterparty interaction, even if absolute publicity may in some places bias user choices in order to harm overall outcomes. Performance data on specific wells, for example, can be a trade secret which users require to be withheld (until disposing of assets). Moreover, not every infield transaction is relevant forever—even if their net influence on a user's credentials is.

Therefore, Cardano's basic structure of separation in accounting and transaction layers allows non-fungible sidechain assets to be tokenized, and provide for exclusive use within the system DAO, are more suitable for unique off-chain assets (such as mineral rights) and can function as deeper stores of data such as geolocation and user reputation metrics, but without collapsing the functionality of either medium. This separation also means the protocol has greater flexibility to design smart contracts beyond standard operator agreements, fluid-delivery, or royalty disbursement agreements.

An embodiment of the present invention provides interoperability between human work and machine work. Tangle cryptography protocol provides advantages not possessed by the Ethereum blockchain when deployed in machine-based applications. Other protocols may also be used in the system of the invention. Tangle's capacity to anchor both interconnected devices and human inputs augments transaction rapidity and transparency of data verification, are especially useful as oilfield automation increases. Moreover, embodiments of the present invention can provide desirable results in other areas of the energy ecosystem. Thus, reliance on the Tangle protocol allows greater scalability and decreased bloat, by decreasing the “cryptographic weight” of the asset token, thus making the ecosystem more nimble and durable.

The Tangle protocol also offers zero or ultra-low-fee transactions and requires no miners. Because it functions above the blockchain, there is no need for miners to process blocks of transactions, there is no motivation to centralize the system's oilfield production verification element. Global adoption is enhanced by minimizing block sizes to the maximum extent possible. Because the Tangle protocol component of the system logic carries the activity reflecting the highest data demand, the entire network becomes much more nimble and scalable.

By regularly interacting with the asset token, the system engine of hydrocarbon flow verification in Tangle protocol can send transactions onto the blockchain without producing the full impact on the asset token's block size. Likewise, Tangle's verification method removes many of the centralization problems traditional mining creates, which also future-proofs the system against mining takeovers in national jurisdictions sponsored by oil sales as well as the potential for quantum computing attacks.

Eventually, with the integration of compatible wellhead equipment, in an embodiment, a wellhead will be able to pay its assembly, its maintenance, its energy and its liability insurance, thus automating the currency buyback function.

Because of Tangle's capacity to handle nanotransactions, real-time streaming of wellhead data will have the ability to automatically impact real-time purchases of the currency on public markets from operator wallets. This will limit the need to store entire production histories in the asset's token by creating reference to the purchasing power returned to the system's DAO members via buybacks. This further ameliorates the need for miners to validate wellhead transaction data at the tokenized asset level, keeping block size smaller. Additionally, embodiments of the present invention can preferably partner with companies to provide enhanced asset performance provenance and augment data delivery on portfolio assets to the system DAO.

While the Tangle protocol's machine-to-machine application requires specified equipment, which is already in use in newer wells, it will also require system adoption downstream. The rapidity of payment and authentication translates into expansive cumulative savings on marginal transactions—the main pain-point for master limited partnerships—and will also create hedging cost savings.

In one embodiment, the present invention can be used for pipeline and trucking payments, and other commodities. User interface features can optionally be added for deepening project analytics and broadening network monitoring.

Service provider adoption: In one embodiment, service providers must accept the currency in lieu of oilfield service work, which, absent a robustly-trading public market for the currency, they may refuse, perceiving it as carrying the operator's expenses (despite the option to immediately sell at market for other cryptocurrency, and later, fiat currency). Even after the market has shown early success and returns, these service providers may be reluctant for many years. The system builds dedicated user adoption teams for each user type to actively recruit users.

Furthermore, in an embodiment, the catalyst portfolio will be arranged principally to provide ongoing liquidity from wellhead cashflows to the token secondary/public market to galvanize vendor transaction clearing. The greater the number of projects funded by the ecosystem, the more diverse and numerous the currency token buying pool participants, which we expect will translate into greater and greater transaction clearing speeds and lower spreads as the ecosystem matures.

Valuation drivers and correlation to commodity prices: In an embodiment currency prices track closely to pricing, e.g. West Texas Intermediate (WTI) pricing, both in correlation and long-term value accretion.

It is reasonable to expect that the degree of currency price volatility should attribute to both crypto and commodity price volatility. Both cryptographic and commodity instrument pricing are constructed from various speculative premiums, and either source could affect the currency pricing from day to day. As a consequence of the currency's prospective, potential dividend payment in ETH or BTC, a trading pair between the currency and the major cryptocurrencies should be strengthened and drive cross-correlations toward cryptocurrency dynamics. In an embodiment, the currency's fundamental bid is driven by price-insensitive open market orders by operators, which virtuously latches the purchasing power of the currency to the purchasing power of wellhead volumes, though ultimately commodity pricing will affect the long-run purchasing power repatriated to the currency.

In an embodiment, the currency's premium to an index is driven by several factors. The first is preferably the discounted value of prospective wellhead volumes contributing to the ecosystem, priced according to a series of complex influences such as the manner in which assets fit their projected decline curves, as well as the commodity price curves which extend into the future several years. Second is preferably the value of the DAO logic and mechanism itself, offering speed and authentication, advanced investment governance and risk management protocols. The system's risk management protocols and autonomous capital budgetary constraints seek to mimic a high stock-to-flow balance of the assets pledged to the DAO and the in- and out-flows of capital expenditure and repatriation. This way, the currency may more closely approach a store of value leveraged to a flatter and less volatile commodity price curve than to the more volatile spot market alone. Third, the potential asset mix eventually funded by the system will not be all exploration-driven. A more exploration-heavy portfolio will tend to be more front-loaded in terms of production and realized token purchases, and therefore more volatile and more leveraged to spot prices vs. futures curves. Existing production pledged by operators and the inclusion of royalties, etc., works to dampen potential volatility.

In an embodiment of the present invention, in the initial stages, the system deploys presale and public token sale capital proceeds directly into energy projects to catalyze the ecosystem and establish the cycle of capital formation from which currency holders' benefit. From presale proceeds, the system identifies a strategic niche in acquisition of overriding royalties which are tokenized, providing a consistent fiat purchasing power cash flow for the acquisition of currency—a fundamental market bid. The system also curates investment terms and guidelines for an energy portfolio (“catalyst portfolio”) which expresses the broadest configuration of risk and return dimensions that ultimately characterizes the DAO's portfolio. Simultaneously the system selects investor partners, which become the first (small) population of investor nodes. These investors will in turn select operators and operators' projects which conform to the system-configured portfolio. In an embodiment, these projects are artificially “greenlighted”, as the user interface is being constructed, and receive funding to develop these energy projects.

In an embodiment of the present invention, in subsequent stages, after the DAO is launched, the capital from this capital pool is deployed into the currency market to buy back tokens. At this stage, operators will then begin normal operations, buying tokens on the open market. These held-back tokens will principally be used to incentivize early user adoption, and the remaining may then be sold once again into the token secondary market. Buybacks and resales are done at random time and size increments within these time horizons in a manner which avoids inducing artificial token price volatility. These token transaction operations are intended to prime the market with sturdy energy projects while supporting token values over the long run, and not inducing large amounts of price volatility at any time.

Portfolio details: The system uses token presale proceeds in part to accumulate a position of producing energy assets and reserves which provides a valuation anchor and validator for the public token generation event.

In an embodiment, the system's channel checks and analysis indicate a wave of energy asset acquisitions beginning to develop on account of recovered commodity prices. Due to peculiar collateralization conventions, however, bank debt has frequently been insufficient to fully capitalize asset acquisitions. As a consequence, acquirers must often sell an overriding royalty to raise cash to complete these capitalizations. The system utilizes presale capital proceeds to purchase such overriding royalties at reasonable present values based on thoroughly analyzed production profiles. These overriding royalties are tokenized as the first properties held by the system DAO, and function as the firm “buying buyers” of the currency from the outset of coin tradability on secondary exchanges.

In an embodiment, the system contracts with several energy advisory, private equity and operator firms to drive user adoption through their portfolios or operations in order to form the original energy asset portfolio and population of users. The original energy asset portfolio to be held by the system DAO is configured by the system holdings in-house, prescribing the overall portfolio profile and conceptualizing individual portfolio positions. These third-party firms will then be tasked with selecting individual energy assets to populate these concepted portfolio positions, also thereby becoming the original slate of “investor intelligence nodes” themselves. These “nodes”, via the system's voting rewards and reputation system, will be incentivized to continue to recruit projects they deem worthy of a submission to the network for funding and drive user adoption through deal funding, including operator and service provider teams.

In an embodiment, the pump-priming stage may be important, because the initial slate of projects which add capital into the public market for currency are in essence responsible for creating some of the liquidity in, and the fundamental ongoing bid for, the currency. Once the ecosystem is “preloaded” with buyers of the currency, decentralization of the investment governance architecture is deployed. Beyond these core assets, the system's holdings will not select projects outright.

Therefore, instead of selecting the actual energy assets, and after prescribing portfolio parameters, the system shifts its role toward selecting third party investor nodes to in turn select operators which will submit viable new hydrocarbon assets and projects. While these investor node firms will end up as the longest-running members of the ecosystem, with a head start on developing the reputations represented within, they will not end up as the only investor nodes. Meanwhile, these new projects anchor the system ecosystem by issuing working interests to the DAO in exchange for development capital. In an embodiment, the system's ultimate role is to launch an integrated, decentralized capital allocation mechanism, not to pick winners and losers whether they be assets, investors, vendors or operators.

In an embodiment, these initial projects build a bid into the currency's market capitalization and provide the liquidity to the second stage of would-be operators which the company, in part, will recruit. New exploration firm entrants will serve as secondary test use cases for the network and protocol, tokenizing properties, working interests and other forms of securitization.

In an embodiment, as the initial slate of projects make working interest distributions to coin holders via currency purchases, adding back cash and creating a competitive bid (at least temporarily), secondary market coin prices will rise both in response to the demand function as well as the operator function which will constrict supply. Ultimately, as hundreds of independent operators/projects add cash flow into the market, coin values expand.

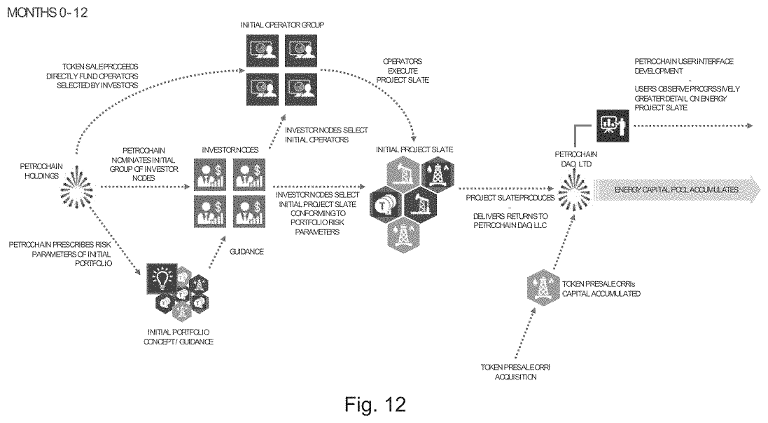

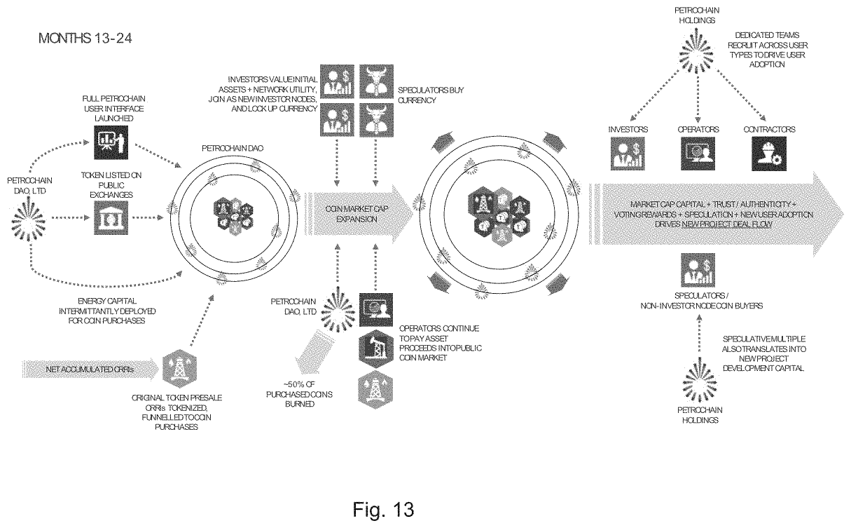

Referring to FIGS. 12-13, these diagrams illustrate the initial stages of funding the system (e.g. months 0-12) and subsequent funding states of the system (e.g. months 13-24).

Optionally, embodiments of the present invention can include a general or specific purpose computer or distributed system programmed with computer software implementing steps described above, which computer software may be in any appropriate computer language, including but not limited to C++, FORTRAN, BASIC, Java, Python, Linux, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

Note that in the specification and claims, “about” or “approximately” means within twenty percent (20%) of the numerical amount cited. All computer software disclosed herein may be embodied on any non-transitory computer-readable medium (including combinations of mediums), including without limitation CD-ROMs, DVD-ROMs, hard drives (local or network storage device), USB keys, other removable drives, ROM, and firmware.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguring their relationships with one another.

What is claimed is:

1. A method for group evaluation and funding of projects with accountability comprising:
an operator proposing a project;
forming a group of voters and allowing the group of voters to vote to approve or disapprove the project;
forming a group of investors to fund an approved project, wherein funds are provided in the form of cryptocurrency tokens;
disbursing revenue from the project to the group of investors in the form of cryptocurrency tokens; and
assigning a score to the operator based at least in part on the successful completion of the project.

2. The method of claim 1 wherein proposing a project comprises accepting entry of details relating to the project from the operator in a portal.

3. The method of claim 2 wherein accepting entry of details relating to the project comprises accepting entry of details relating to at least one of an oil drilling project, a natural gas drilling project, an oil and natural gas drilling project, and a natural resources project.

4. The method of claim 1 further comprising requiring the operator to pay collateral for the proposed project.

5. The method of claim 4 wherein the collateral is in the form of cryptocurrency tokens.

6. The method of claim 1 further comprising rewarding at least one of the group of voters.

7. The method of claim 6 wherein rewarding at least one of the group of voters is accomplished via payment of the cryptocurrency tokens.

8. The method of claim 1 comprising disclosing an operator's assigned score to the group of voters.

9. The method of claim 1 further comprising allowing for a real-time audit while carrying out the project.

10. A method for group evaluation and funding of projects with accountability comprising:
an operator proposing a project;
voting by a group of voters to approve or disapprove the project;
the operator posting at least some collateral in the form of cryptocurrency;
forming a group of investors to fund an approved project, wherein funds are provided in the form of cryptocurrency tokens;
disbursing revenue from the project to the group of investors in the form of cryptocurrency tokens; and
rewarding at least one of the group of voters from the collateral posted by the operator.

11. The method of claim 10 further comprising rewarding at least one of the group of voters based on a history of voting to approve projects that were found to be profitable.

12. The method of claim 11 wherein rewarding at least one of the group of voters comprises assigning the voter an increased share of an operator's voter incentive bonding.

13. The method of claim 11 wherein rewarding at least one of the group of voters comprises increasing voting power of the at least one voter for subsequent projects.

14. The method of claim 9 wherein the group of voters comprise staked currency holders.

15. The method of claim 9 further comprising providing for execution of multi-signature smart contracts in conjunction with the proposed project.

16. The method of claim 9 further comprising allowing for a real-time audit while carrying out the project.

17. Non-transitory computer-readable medium comprising machine-readable code, said medium comprising:
code allowing an operator to propose a project;
code forming a group of voters and allowing the group of voters to vote to approve or disapprove the project;
code forming a group of investors to fund an approved project;
code providing funds in the form of cryptocurrency tokens;
code disbursing revenue from the project to the group of investors in the form of the cryptocurrency tokens; and
code assigning a score to the operator based at least in part on the successful completion of the project.

18. The non-transitory computer-readable medium of claim 17 further comprising code permitting real-time auditing of the project.

19. Non-transitory computer-readable medium comprising machine-readable code, said medium comprising:
code allowing an operator to propose a project;
code permitting voting by a group of voters to approve or disapprove the project;
code for collecting at least some collateral in the form of cryptocurrency;
code forming a group of investors to fund an approved project;
code distributing funds which are in the form of the cryptocurrency tokens;
code disbursing revenue from the project to the group of investors in the form of cryptocurrency tokens; and
code rewarding at least some of the group of voters from the collateral posted by the operator.

20. The non-transitory computer-readable medium of claim 19 further comprising code rewarding at least one voter based on a history of voting to approve projects that were found to be profitable.

21. The non-transitory computer-readable medium of claim 19 further comprising code permitting real-time auditing of the project.

22. The non-transitory computer-readable medium of claim 19 further comprising code providing for execution of multi-signature smart contracts in conjunction with the proposed project.
